(19) United States
(12) Patent Application Publication
(10) Pub. No.: US 2015/0126216 A1
(43) Pub. Date: May 7, 2015

(54) COMMUNICATION DEVICE

(71) Applicant: JACKTRAK LIMITED, West Sussex (GB)

(72) Inventor: Robert Mullins, Surrey (GB)

(21) Appl. No.: 14/399,908

(22) PCT Filed: May 13, 2013
(86) PCT No.: PCT/GB2013/051230

§ 371 Date: Nov. 7, 2014

(30) Foreign Application Priority Data
May 11, 2012 (GB) 1208294.7

(51) Int. Cl. H04W 4/02

(52) U.S. Cl. CPC H04W 4/023
USPC 455/456.1

(57) ABSTRACT

A communication device (1) operable to communicate with another communication device (3) to determine the location of the two devices with respect to one another, the communication device having a plurality of antennas (5, 7, 9) and being configured to transmit an interrogation radio wave signal (11) to the other communication device from at least one of the antennas, the communication device being configured to detect at each one of the antennas a radio wave reply signal sent from the other communication device in response to the interrogation signal; the communication device including a processing module for processing the reply signal received at each antenna, the processing module being configured to determine a direction in which the other communication device is located based on characteristics of the reply signal as received at each antenna.

### FIELD OF THE INVENTION

The present invention relates to a communication device that is operable to communicate with a second communication device to determine the location of the two devices with respect to one another.

### BACKGROUND

The need to locate the whereabouts of people and/or objects that may not be immediately visible to a person has spurred the development of several types of electronic tagging systems. In such systems, an electronic tag is either worn by a person or affixed to an object. Wireless technology can then be used to communicate the position of the tag to a reader.

Typically, these systems rely on the use of small low power transmitters, for example radio frequency ID tags (RFID tags). The reader broadcasts signals to, and receives signal from the tag in order to map its location.

As wireless technology has grown more sophisticated, it has become possible to remotely locate objects or people within ever shorter time frames. Systems that accomplish this are called real time location systems (RTLS). Whilst effective, these systems do present problems. For example, they may cease to function over long ranges, or fail to locate items to within an acceptable degree of accuracy.

Thus, there is a continuing need to develop new tracking technologies for locating people and objects for use in both home and industry.

### SUMMARY OF INVENTION

According to a first aspect of the invention, there is provided a communication device operable to communicate with another communication device to determine the location of the two devices with respect to one another,
the communication device having a plurality of antennas and being configured to transmit an interrogation radio wave signal to the other communication device from at least one of the antennas,
the communication device being configured to detect at each one of the antennas a radio wave reply signal sent from the other communication device in response to the interrogation signal;
the communication device including a processing module for processing the reply signal received at each antenna, the processing module being configured to determine a direction in which the other communication device is located based on characteristics of the reply signal as received at each antenna.

In some embodiments, the communication device is a hand-held device. In other words, the communication device is small enough to be held and operated within the hand of a user.

The processing module may be operable to sample the signal from each antenna in a plurality of sampling windows, wherein the sampling windows used for each individual antenna are offset in time from the sampling windows used for the other antennas. The sampling windows for each antenna may be wholly offset from one another, such that only one antenna is sampled at a time.

The processing module may be operable to sample the signal from each antenna at an integer multiple of the carrier frequency of the signals exchanged between the communication device and other communication device. For example, the processing module may sample the signal from each antenna at twice the carrier frequency, or four times the carrier frequency, or eight times the carrier frequency.

Where the signals exchanged between the communication device and other communication device are transmitted over a band of carrier frequencies, the processing module may be operable to sample the signal from each antenna at an integer multiple of the middle frequency of the band, or the highest frequency in the band. For example, the processing module may sample the signal from each antenna at twice the highest carrier frequency, or four times the highest carrier frequency, or eight times the highest carrier frequency in the band.

Typically, the processing module will sample the signal from each antenna at a frequency in excess of 1 GHz.

The processing module may be configured to sample the signal received at each antenna in sequence.

The processing module may be operable during the period in which said at least one antenna is transmitting the interrogation signal to sample the signal from the other antennas.

The communication device may include a switch for selecting which one of the antenna signals is to be input to the processing module for sampling at any one time.

The processing module may be configured to determine the direction in which the other communication device is located at least partly based on the time intervals that occur between sending the interrogation signal from said at least one antenna and receiving the response signal at each antenna. The processing module may be configured to determine the direction in which the other communication device is located at least partly based on the difference in amplitude between the signals that are received at each antenna.

The communication device may be configured to transmit a signal to the other communication device indicating the direction in which the communication device is located with respect to the other communication device.

The antennas of the communication device may be configured to transmit at frequencies in the range 2.4-2.5 GHz. The antennas may be configured to transmit within an ultra wide frequency band having 500 MHz bandwidth, in the range 3.1-10.6 GHz. Each interrogation signal may comprise a chirped signal. The reply signal received from the other communication device may also comprise a chirped signal.

The communication device may be operable to determine the antenna that is closest to the other communication device based on characteristics of the reply signal as received at each antenna.

The device may be operable to transmit a second interrogation signal in response to the reply signal sent from the other communication device. Following transmission of the second interrogation signal, the communication device may be operable to adjust the sampling windows for the antennas, such that the processing module will sample the signal from the antenna identified as being closest to the other communication device for a greater portion of time compared to the other antennas. On receiving a reply signal sent from the other communication device in response to the second interrogation signal, the communication device may be configured to reassess which one of the antennas is closest to the other communication device. Where the communication device determines that a different one of the antennas is now closest to the other communication device, the communication device may adjust the sampling windows, so that following the transmission of a further interrogation signal from the communication device, the communication device will sample the signal from the antenna newly identified as being closest to the other communication device for a greater portion of time compared to the other antennas.

The communication device may be operable to determine the pair of antennas that are closest to the other communication device based on characteristics of the reply signal as received at each antenna.

The device may be operable to transmit a second interrogation signal in response to the reply signal sent from the other communication device. Following transmission of the second interrogation signal, the communication device may be operable to adjust the sampling windows for the antennas, such that the processing module will sample the signal from the pair of antennas identified as being closest to the other communication device for a greater portion of time compared to the other antennas. On receiving a reply signal sent from the other communication device in response to the second interrogation signal, the communication device may be configured to reassess which pair of antennas is closest to the other communication device. Where the communication device determines that a different pair of antennas is now closest to the other communication device, the communication device may adjust the sampling windows, so that following the transmission of a further interrogation signal from the communication device, the communication device will sample the signal from the pair of antennas newly identified as being closest to the other communication device for a greater portion of time compared to the other antennas.

The communication device may be configured to transmit interrogation signals from a plurality of the antennas. The communication device may include a multiplexer for selecting which one of the antennas is to transmit an interrogation signal and which one of the antennas is to be sampled by the processing module at any one time. The interrogation signal sent from each antenna may be encoded with a different format. The communication device may be configured to assign each antenna its own code for modulating the frequency of interrogation signals transmitted from that antenna. The communication device may be configured to assign each antenna a different frequency or band of frequencies for transmitting interrogation signals.

The communication device may be operable to communicate with a plurality of other communication devices. The interrogation signals sent to any one of the other communication devices may be encoded in a format that is specific to that device.

The communication device may include a means for displaying the direction in which the other communication device is located with respect to the communication device.

The communication device may include at least 3 antennas. The antennas may be arranged in a planar array, in which each antenna defines a vertex of a polygon. The communication device may include 4 antennas located at the corners of a square.

According to second aspect of the invention, there is provided a system for tracking the location of an object of interest, the system comprising a communication device according to any one of the preceding claims and a second communication device, the second communication device being configured to receive interrogation signals sent from the communication device and to transmit reply signals in response back to the communication device.

The communication device may be configured to transmit interrogation signals from a plurality of the antennas with each antenna being assigned its own code for modulating the frequency of interrogation signals transmitted from that antenna. The second communication device may be configured to recognise the format of each interrogation signal and to encode the respective response signals using the same format.

According to a third aspect of the invention, there is provided a method of tracking the position of a second communication device with respect to a first communication device having a plurality of antennas, the method comprising:
sending an interrogation radio wave signal to the second communication device from at least one of the antennas of the first communication device;
receiving a radio wave reply signal sent from the second communication device at each one of the antennas;
and determining a direction in which the second communication device is located based on characteristics of the reply signal as received at each antenna.

The method may comprise sampling the signal from each antenna in a plurality of sampling windows, wherein the sampling windows used for each individual antenna are offset in time from the sampling windows used for the other antennas. The sampling windows for each antenna may be wholly offset from one another, such that only one antenna is sampled at a time. The method may comprise sampling the signal from each antenna at a rate in excess of 1 GHz.

The method may comprise sampling the signal from each of the other antennas whilst said at least one antenna is transmitting an interrogation signal. The method may comprise determining the direction in which the other communication device is located at least partly based on the time intervals that occur between sending the interrogation signal from said at least one antenna and receiving the response signal at each antenna. The method may comprise determining the direction in which the other communication device is located at least partly based on the difference in amplitude between the signals that are received at each antenna.

The method may comprise transmitting a signal to the other communication device indicating the direction in which the communication device is located with respect to the other communication device.

The method may comprise determining the antenna that is closest to the other communication device based on characteristics of the reply signal as received at each antenna. The method may comprise transmitting a second interrogation signal in response to the reply signal sent from the other communication device. Following transmission of the second interrogation signal, the sampling windows for the antennas may be adjusted so as to sample the signal from the antenna identified as being closest to the other communication device for a greater portion of time compared to the other antennas. The method may comprise reassessing, on receipt of a reply signal sent from the other communication device in response to the second interrogation signal, which one of the antennas is closest to the other communication device. Where it is determined that a different one of the antennas is now closest to the other communication device, the sampling windows may be adjusted, so that following the transmission of a further interrogation signal from the communication device, the communication device will sample the signal from the antenna newly identified as being closest to the other communication device for a greater portion of time compared to the other antennas.

The method may comprise determining the pair of antennas that are closest to the other communication device based on characteristics of the reply signal as received at each antenna. The method may comprise transmitting a second interrogation signal in response to the reply signal sent from the other communication device. Following transmission of the second interrogation signal, the sampling windows for the antennas may be adjusted so as to sample the signal from the pair of antennas identified as being closest to the other communication device for a greater portion of time compared to the other antennas. The method may comprise reassessing, on receipt of a reply signal sent from the other communication device in response to the second interrogation signal, which pair of antennas is closest to the other communication device. Where it is determined that a different pair of antennas is now closest to the other communication device, the sampling windows may be adjusted so that following the transmission of a further interrogation signal from the communication device, the communication device will sample the signal from the pair of antennas newly identified as being closest to the other communication device for a greater portion of time compared to the other antennas.

The method may comprise transmitting interrogation signals from a plurality of the antennas. Each antenna may be assigned its own code for modulating the frequency of interrogation signals transmitted from that antenna. Each antenna may be assigned a different frequency or band of frequencies for transmitting interrogation signals.

The method may comprise displaying, on a display means, the direction in which the other communication device is located with respect to the communication device.

According to a fourth aspect of the present invention, there is provided a communication device operable to communicate with another communication device to determine the location of the two devices with respect to one another,
the communication device having a plurality of antennas, each one of the plurality of antennas being configured to transmit an interrogation radio wave signal to the other communication device and to receive a respective radio wave reply signal from the other communication device;
the communication device including a processing module for processing the reply signal received at each antenna;
the processing module being configured to determine a direction in which the second communication device is located based on characteristics of the reply signal received at each antenna.

The processing module may be configured to determine the direction in which the other communication device is located based on the time intervals that occur between sending an interrogation signal from each antenna and receiving a corresponding reply signal at the same antenna. The processing module may be configured to determine the direction at least partly based on a difference in amplitude between the signal that is sent from each antenna and the signal that is received at each antenna.

The processing module may be configured to determine the distance between the communication device and the other communication device based on characteristics of the signal received at each antenna. The processing module may be configured to determine the distance between the communication device and the other communication device based on the time intervals that occur between sending an interrogation signal from each antenna and receiving a corresponding reply signal at the same antenna.

The antennas of the communication device may be configured to transmit to the other communication device in sequence.

The antennas may be configured to transmit further interrogation signals in response to the reply signals sent from the other communication device. For each round of interrogation, the processing module may be configured to sample the resultant reply signal received at each antenna. The processing module may be configured to determine the direction based on reply signals received over several rounds of interrogation.

In some embodiments, the communication device includes a means for monitoring movement of the communication device. The means may comprise an accelerometer, or gyroscope, for example. Such means can be used to compensate for movement of the communication device. For example, where the position of the other communication device does not change, but the communication device rotates for example, it may be possible to determine the extent of rotation and in turn recalculate the direction in which the other communication device is located, without having to send further interrogation signals to the other communication device.

The interrogation signals sent from different antennas of the plurality of antennas may have different chirp rates. The signals received from the second communication device may also be chirped. The use of chirp may, for example, help to increase the bandwidth of the signal and reduce the effects of interference on the transmitted signals.

In some embodiments, the processing module is configured to determine the direction at least partly based on a difference in linearity between the chirp signal that is sent from each antenna, and the chirp signal that is received at each antenna.

In some embodiments, the communication device may be capable of communicating with a plurality of second communication devices and determining the location of each second communication device with respect to the communication device. In order to avoid interference between the signals from each of the second communication devices, the interrogation signals sent to any one of the second communication devices may be encoded in a format that is specific to that device. Similarly, the communication device may be configured to recognise response signals that are encoded in different formats, and to associate those signals with specific devices.

According to a fifth aspect of the present invention, there is provided a method of tracking the position of a second communication device with respect to a first communication device having a plurality of antennas, the method comprising:
sending an interrogation radio wave signal to the second communication device from each one of the plurality of antennas;
receiving a respective radio wave reply signal from the second communication device at each antenna; and
determining a direction in which the second communication device is located based on characteristics of the reply signal received at each antenna.

In some embodiments, the method comprises determining the direction in which the second communication device is located based on the time intervals that occur between sending an interrogation signal from each antenna and receiving a corresponding reply signal at the same antenna.

In some embodiments, the method comprises determining the direction at least partly based on a difference in amplitude between the signal that is sent from each antenna, and the signal that is received at each antenna. In some embodiments, the method comprises determining the distance between the first communication device and the second communication device based on characteristics of the signal received at each antenna. In some embodiments, the method comprises determining the distance between the first communication device and the second communication device based on the time intervals that occur between sending an interrogation signal from each antenna and receiving a corresponding reply signal at the same antenna.

In some embodiments, the method comprises transmitting further interrogation signals in response to the reply signals received from the second communication device;
for each round of interrogation, sampling the resultant reply signal received at each antenna; and
determining the direction based on reply signals received over several rounds of interrogation.

According to a sixth aspect of the present invention, there is provided a system for tracking the location of an object of interest, the system comprising first and second communication devices;
the first communication device having a plurality of antennas, each one of the plurality of antennas being configured to transmit an interrogation radio wave signal to the second communication device and to receive a respective radio wave reply signal from the second communication device;
the first communication device including a processing module for processing the reply signal received at each antenna;
the processing module being configured to determine a direction in which the second communication device is located based on characteristics of the reply signal received at each antenna.

In some embodiments, the second communication device is configured to recognise the format of each interrogation signal and to encode the respective response signals using the same format.

In some embodiments, the first and second communication devices may include sensors for determining the height above ground of the devices. For example, the first and second communication devices may each include a respective barometer. By transmitting the barometer reading from the second communication device to the first communication device, for example, the first communication device can determine a difference in elevation between the two devices. The height information may be transmitted using the same antenna or antennas that are used to determine the location of the second communication device with respect to the first communication device. The sensor information may be transmitted as a signal having a particular encoding, which can then be recognised by the processing module as information pertaining to the height of the second communication device.

According to a seventh aspect of the present invention, there is provided a computer readable storage medium containing instructions executable by a computer processor to cause the computer to carry out a method according to the third or fifth aspect.

### BRIEF DESCRIPTION OF DRAWINGS

Embodiments of the invention will now be described by way of reference to the accompanying drawings in which:

FIG. 1 shows a schematic of a communication device according to an embodiment;

FIG. 2 shows a sequence of signals transmitted from and received by the communication device of FIG. 1;

FIG. 3 shows a timeline of the signals transmitted from and received by the antennas of the communication device of FIG. 1;

FIG. 4 shows an example in which the signals shown in FIG. 3 are sampled in different time windows by a receiver of the communication device;

FIG. 5 shows the components of the communication device of FIG. 1, together with the components of a second communication device from which the communication devices receives response signals;

FIG. 6 shows a more detailed view of the components of the communication device shown in FIG. 5, including a switch for selecting which one of the antennas the received response signals are to be sampled from;

FIG. 7 shows an example of how the switch of FIG. 6 may be used to switch between the different antennas;

FIG. 8 shows components of a communication device according to another embodiment;

FIG. 9 shows components of a second communication device, operable to communicate with the device shown in FIG. 8;

FIG. 10 shows examples of chirped interrogation signals and response signals transmitted and received by a communication device according to an embodiment;

FIG. 11 shows an example in which the chirped signals shown in FIG. 10 are sampled in different time windows by a receiver of the communication device;

FIG. 12 shows a schematic of a communication device according to an embodiment, in which the antennas are arranged in a planar array;

FIG. 13 shows a sequence of signals transmitted from and received by the communication device of FIG. 12;

FIG. 14 shows an example in which the signals shown in FIG. 13 are sampled in different time windows by a receiver of the communication device;

FIG. 15 shows another example in which the signals shown in FIG. 13 are sampled in different time windows by a receiver of the communication device;

FIG. 16 shows a flowchart of steps used for defining the sampling windows shown in FIGS. 14 and 15;

FIG. 17 shows components of a communication device according to another embodiment;

FIG. 18 shows a sequence of signals transmitted from and received by the communication device of FIG. 17;

FIG. 19 shows an example of how the switch of FIG. 17 may be used to switch between the different antennas;

FIG. 20 shows a timeline of the signals transmitted from and received by the antennas of the communication device in an embodiment;

FIG. 21 shows components of a communication device according to another embodiment;

FIG. 22 shows a mobile phone handset that includes a communication device according to an embodiment;

FIG. 23 shows an example of the mobile phone handset of FIG. 21 in use according to an embodiment;

FIG. 24 shows an example in which a communication device according to an embodiment is used to broadcast information concerning the location of the second communication device over a wireless network; and

FIG. 25 shows an example in which a communication device according to an embodiment is used to broadcast information concerning the location of the second communication device to a desktop computer over a network.

### DETAILED DESCRIPTION

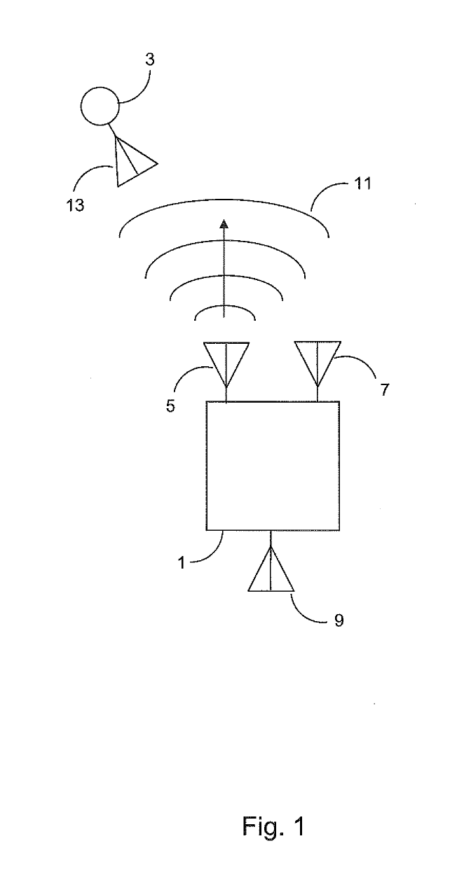

FIG. 1 shows a schematic of a communication device 1 according to an embodiment of the present invention.

In this embodiment, the communication device functions as a tracking device that tracks the location of a second communication device 3 located remotely from the communication device. The second communication device functions as an identification tag that can be used to identify the whereabouts of a person or asset. The second communication device may form part of an accessory worn by a person (for example, a watch or bracelet or an item of clothing). Alternatively, the second communication device may be affixed to or embedded within an object or asset whose whereabouts a person wishes to keep track of.

The first communication device 1 includes a first antenna 5, a second antenna 7, and a third antenna 9, one or more of which communicates with the second communication device by broadcasting interrogation signals 11 in the form of radio frequency signals. In this embodiment, the first communication device comprises a single stand-alone unit—each of the antennas of the first communication device may be contained within, or extend out of, the same single housing.

An interrogation signal can be understood to be a radio wave signal that is broadcast over a region of space, with the intention of eliciting a response signal from another device located somewhere in that region of space. The interrogation signal includes data showing the time at which it was transmitted from the first communication device, as measured by a clock within that communication device.

The second communication device comprises its own antenna 13, which receives the interrogation signals and in response broadcasts its own radio frequency signals. Like the interrogation signals, the response signals include data indicating the time at which they were transmitted from the second communication device, as measured by a clock within that communication device. Once received by the first, second and third antennas, the response signals can be used to determine the direction in which the second communication device is located from the first communication device.

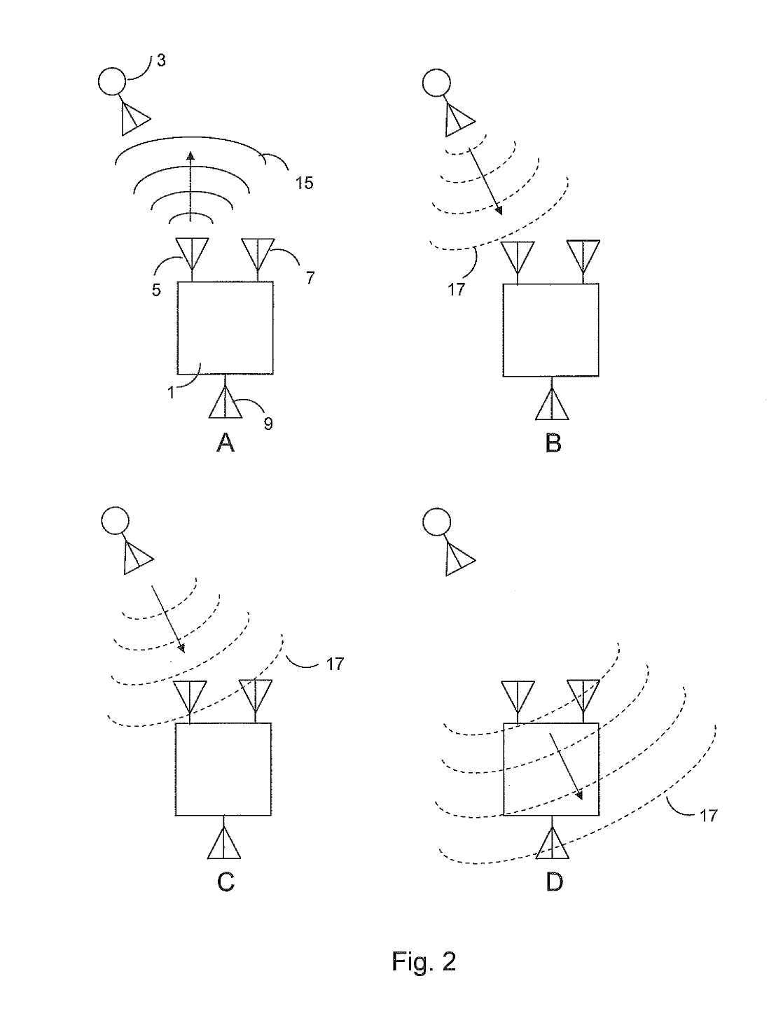

An example sequence for transmitting an interrogation signal from the first communication device and receiving response signals from the tag 3 is illustrated in FIG. 2.

FIG. 2A shows a first moment in time in which the first antenna 5 is transmitting a first interrogation signal 15. The interrogation signal itself comprises a short burst of radio frequency waves. At this stage, the second communication device 3 has yet to receive a signal from the first communication device. Therefore, the second communication device is presently inactive.

FIG. 28 shows the two communication devices at a later point in time, following the receipt of the interrogation signal by the second communication device. Having received the interrogation signal from the first communication device, the second communication device has now begun to broadcast its own signal 17 in response. The leading edge of the response signal has just arrived at the first antenna 5. The first antenna has itself now ceased to transmit, and instead switched to a receiving mode where it can receive and process the response signal. The second and third antennas 7, 9 are also receptive to signals being transmitted by the tag, although the response signal 17 has yet to reach either the second or third antenna.

FIG. 2C shows a yet later point in time. The second communication device has now finished transmitting the first response signal 17. At the first communication device, the response signal 17 is still incident on the first antenna 5, whilst the leading edge of the response signal has reached the second antenna 7. The response signal has not yet reached the third antenna 9, however.

FIG. 2D shows a yet later point in time. The response signal has now passed by the first antenna 5, which is no longer detecting the response signal. The trailing edge of the response signal has now reached the second antenna 7, whilst the leading edge has now reached the third antenna 9. Consequently, at this point in time, the second and third antennas will detect the response signal, whilst the first antenna will not.

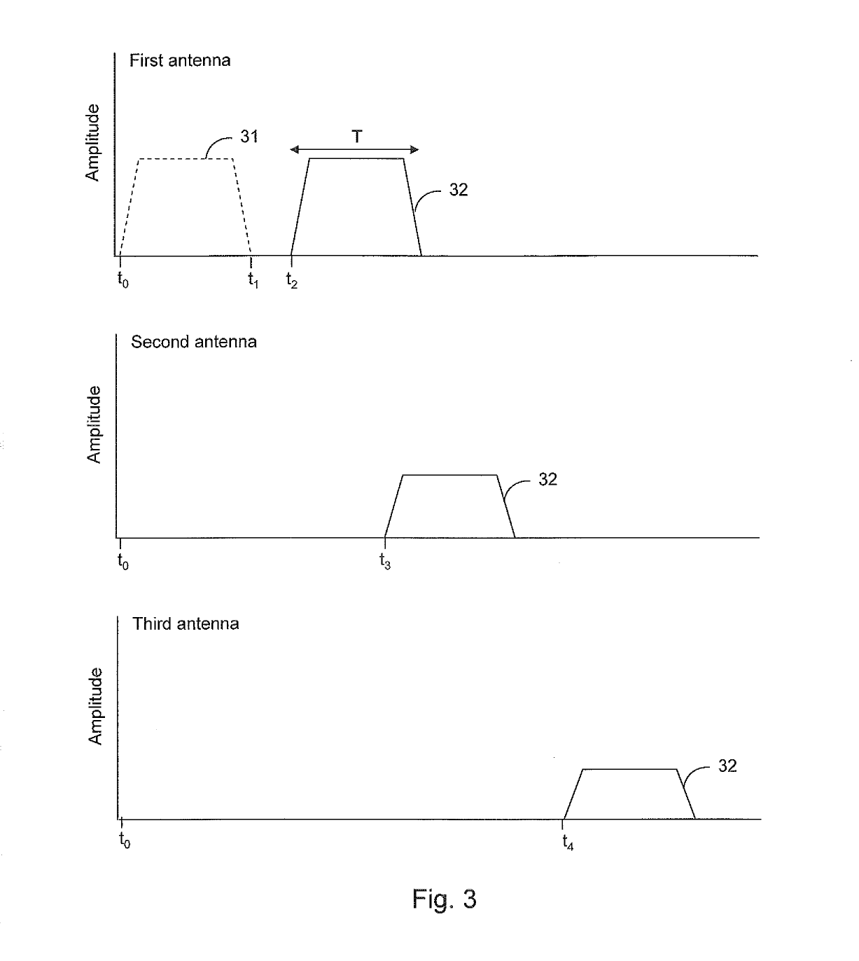

FIG. 3 shows a timeline for the signals received at each antenna in FIG. 2. At time point tₒ, the first antenna beings broadcast of the interrogation signal 31 (shown here in dashed lines). The first antenna completes the transmission of the interrogation signal at t₁. At t₂ the antenna begins to detect the response signal 32 sent from the tag. The response signal (shown here in solid lines) has a duration T. The length of the interval tₒ-t₂ reflects the sum of i) the time taken for the interrogation signal to reach the tag from the first antenna, ii) the time taken for the tag to process the interrogation signal and broadcast the response signal and iii) the time taken for the response signal to reach the first antenna from the tag. Thus, the interval tₒ-t₂ provides an indication of the distance between the first antenna and the tag. The first antenna continues to receive the response signal for the duration T of that signal.

The second antenna first begins to detect the response signal at time t₃, slightly later than the first antenna. As before, the interval tₒ-t₃ provides an indication of the distance between the second antenna and the tag. The interval tₒ-t₃ is greater than tₒ-t₂, reflecting the fact that the distance between the second antenna and the tag is greater than that between the first antenna and the tag. In addition, the amplitude of the signal received by the second antenna is smaller than that received at the first antenna, since the response signal is dispersed over a greater volume of space by the time it reaches the second antenna.

The third antenna begins to detect the response signal at time t₄, later than the both the first and second antennas. As before, the interval tₒ-t₄ provides an indication of the distance between the third antenna and the tag. The interval tₒ-t₄ is greater than both intervals tₒ-t₂, and tₒ-t₃, reflecting the fact that the distance between the third antenna and the tag is greater than both the distance between the first antenna and the tag, and the distance between the second antenna and the tag. Similarly, the amplitude of the signal received by the third antenna is smaller than that received at the first and second antennas.

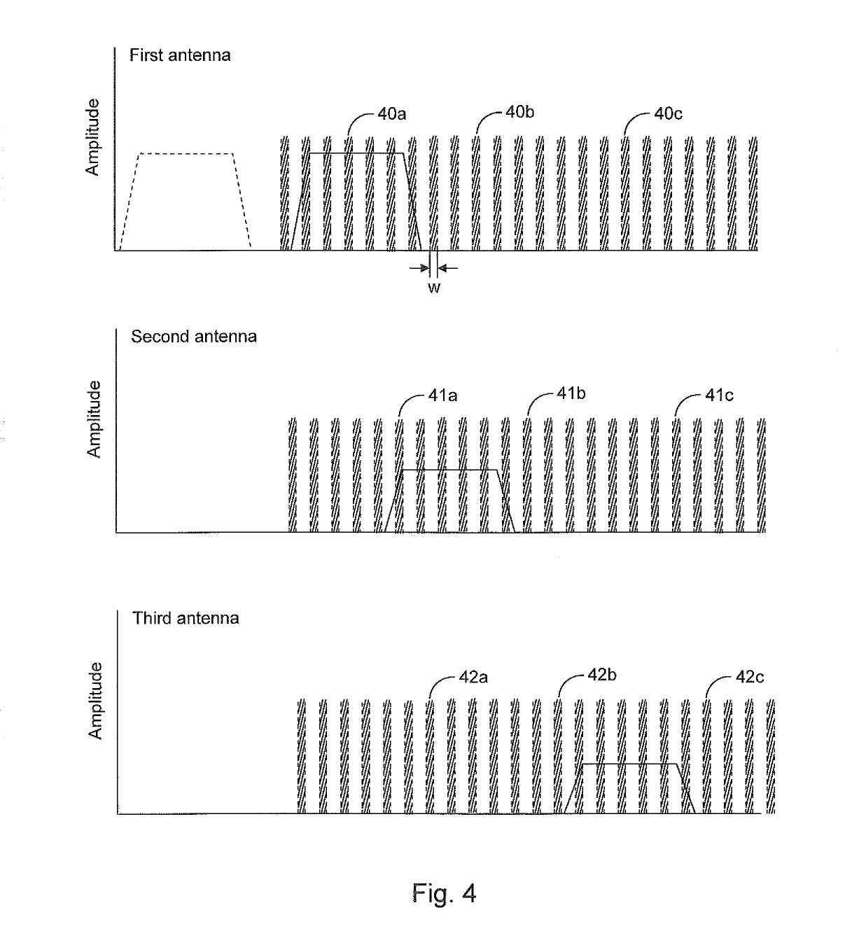

In the present embodiment, the first communication device is configured to sample the signal detected at each antenna at different points in time. This can be understood by reference to FIG. 4, which shows the sampling windows employed for each antenna. Following the transmission of the initial interrogation signal at tₒ, the first communication device is configured to sample the signal detected at the first antenna in each one of a first series of time windows. Each time window is shown in FIG. 4 as a shaded region, exemplified by the three regions labelled 40a, 40b and 40c. Similarly, the first communication device is configured to sample the signal detected at the second antenna in each one of a second series of time windows, again exemplified by shaded regions 41a, 41b and 41c. The first communication device is configured to sample the signal detected at the third antenna at each one of a third series of time windows 42a, 42b and 42c. In this example, each window has the same duration w. However, in other embodiments, the duration of each window and/or the intervals between them may vary. For example, the duration of the time windows and/or the intervals between the windows may vary between the different antennas, as well as within the sequence of windows used for an individual antenna.

As shown in FIG. 4, the sampling windows for each antenna are offset in time from one another. That is, the series of windows used to sample the signal detected by the first antenna (exemplified by regions 40a, 40b and 40c) is offset in time from the series of windows used to sample the signal detected by the second antenna (exemplified by regions 41a, 41b and 41c), which is in turn offset from the series of windows used to sample the signal detected by the third antenna (exemplified by regions 42a, 42b and 42c). At any one time, therefore, the communication device will sample the signal detected at a single one of the antennas.

Typically, the device is configured to sample each antenna at a rate of GHz. That is, the frequency at which the device moves from sampling the signal at one antenna to sampling the signal at the next antenna is in excess of 1 GHz. The width of the sampling window w is, therefore, of the order 1 ns or less. The interrogation and response signals, meanwhile, are typically of the order 1-10 μs in duration (note that, for purpose of explanation, the width of the sampling windows and the duration of the interrogation/response signals have not been drawn to scale in FIG. 4).

The receiver is able to calculate distance information based on the measured interval between an antenna's transmission and when it first detects a response signal in one of the sampling windows. By correlating differences in amplitude and/or time of arrival of the response signal for the respective antennas, it is possible to build up information concerning the location of the second communication device.

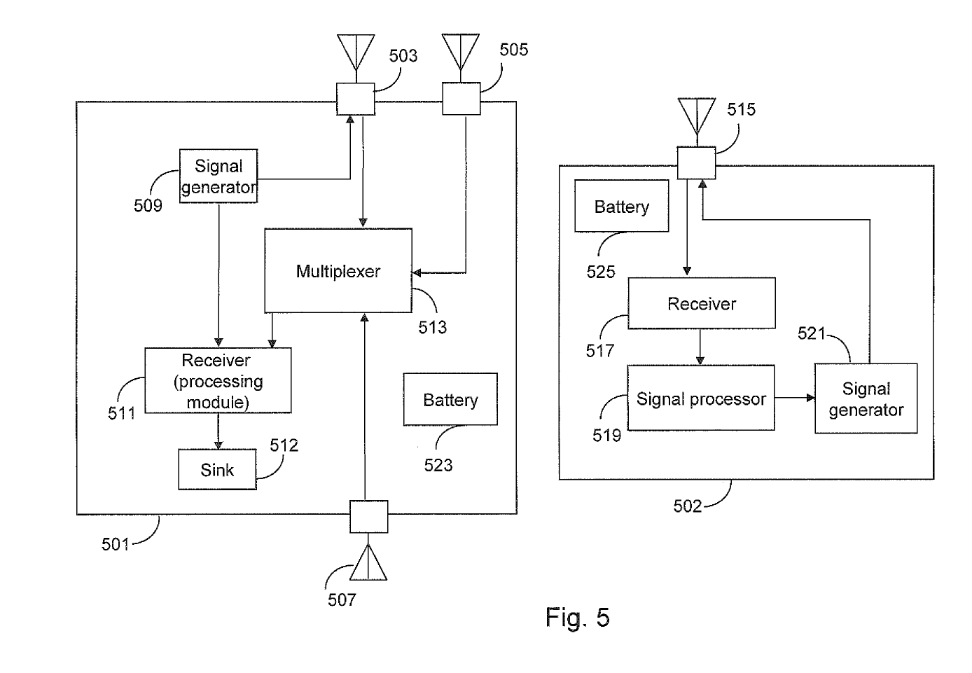

FIG. 5 shows a more detailed view of the components of the first 501 and second 502 communication devices.

In addition to first 503, second 505, and third 507 antennas, the first communication device includes a signal generator 509 that is used to generate the radio frequency interrogation signals that are to be broadcast from the first communication device. The first communication device also includes a receiver 511, which is configured to process the response signals received from the second communication device and a multiplexer 513. The multiplexer is used to coordinate the sampling of the signals detected at each antenna. Once processed by the receiver, signals are sent to a sink 514.

The second communication device has its own antenna 515 which is coupled to a receiver 517. The interrogation signals received by the second communication device are input into a signal processor 519. Upon processing the interrogation signal, the processor causes the second communication device's own signal generator 521 to generate a response signal that will then be broadcast from the antenna of the second communication device.

The first and second communication devices are each powered by a respective battery 523, 525. In some embodiments, the second communication device need not be powered by a battery, but may act as a passive component that draws its power from the radio wave signals actually transmitted by the first communication device.

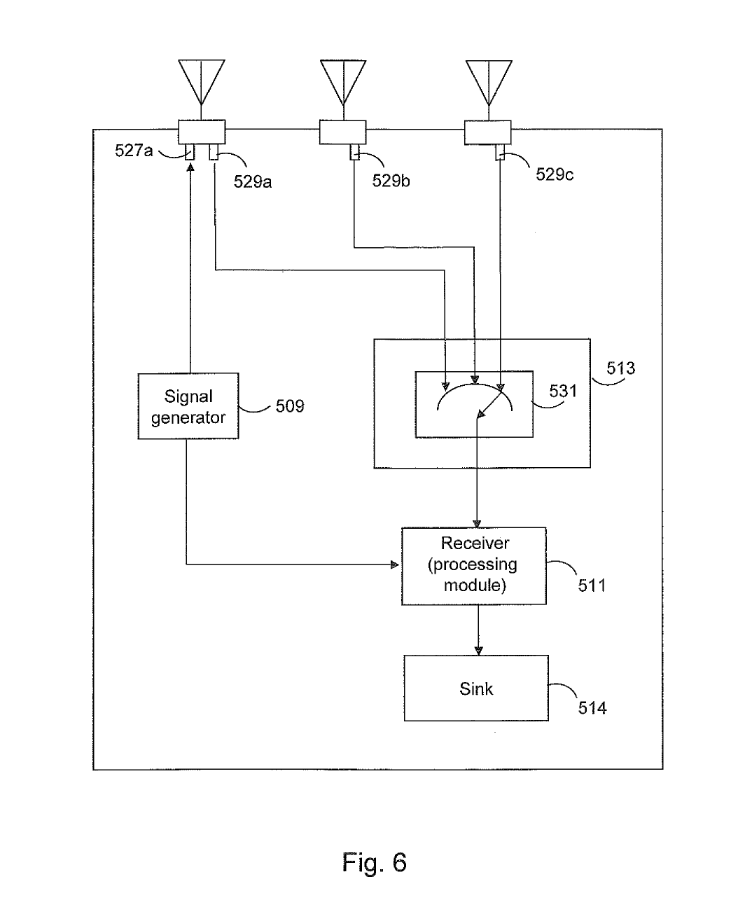

The function of the multiplexer in the present embodiment can be explained by reference to FIG. 6. The first antenna is connected to the signal generator 509 via a feed 527a, for conveying interrogation signals to the first antenna for broadcast towards the tag. Each of the three antennas also has an output feed 529a, 529b, 529c for conveying the signals received at the respective antenna towards the receiver 511.

Each one of the output feeds 529a, 529b, 529c is connected to the multiplexer 513. The multiplexer itself comprises a switch 531 that is used to select one of the three output feeds to be input into the receiver. By switching between the different output feeds, the second switch enables the receiver to sample the signals received by each antenna in turn.

The receiver 511 communicates with the signal generator 509 in order to determine when an interrogation signal is being transmitted from the device. Based on this, the receiver is able to determine a delay between the transmission of an interrogation signal, and the receipt of a response signal at the different antennas.

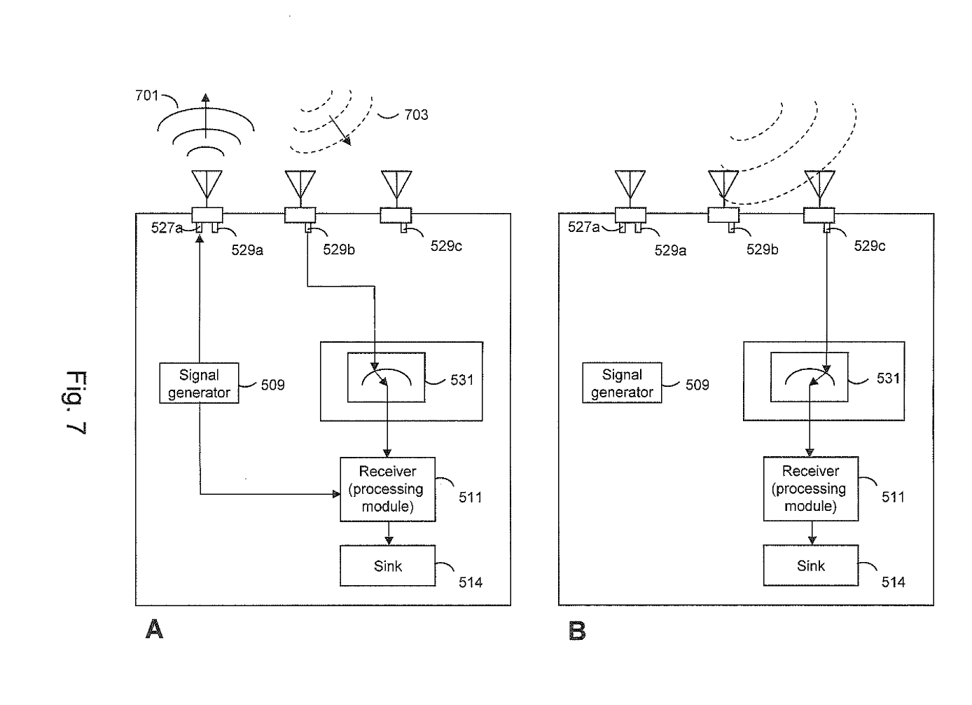

FIG. 7 shows an example of how the multiplexer may work in practice. FIG. 7A shows a first time point in which the first antenna is transmitting an interrogation signal 701. At the same time, a response signal 703 generated by the tag in response to an earlier interrogation signal is just arriving at the first communication device. The switch 531 is presently set to connect the output feed 529b of the second antenna to the receiver 511. At this point in time, therefore, the receiver is set to sample signals received by the second antenna. Neither the first, nor the third antenna is connected to the receiver via the switch 531. Thus, whilst the first and/or third antenna may also be detecting the response signal from the tag, only that part of the response signal that is incident on the second antenna will be sampled and processed in the first communication device at this point in time.

FIG. 7B shows the configuration of the first communication device at a later point in time. Here, the receiver is now set to sample the signals being received by the third antenna. The second antenna meanwhile is now in a similar state to that of the third antenna in FIG. 7A. The first antenna is no longer transmitting an interrogation signal and is in a similar state to that of the second antenna.

In effect, therefore, the multiplexer functions as a high speed switch that defines the windows during which the signals from each antenna are sampled and processed by the receiver.

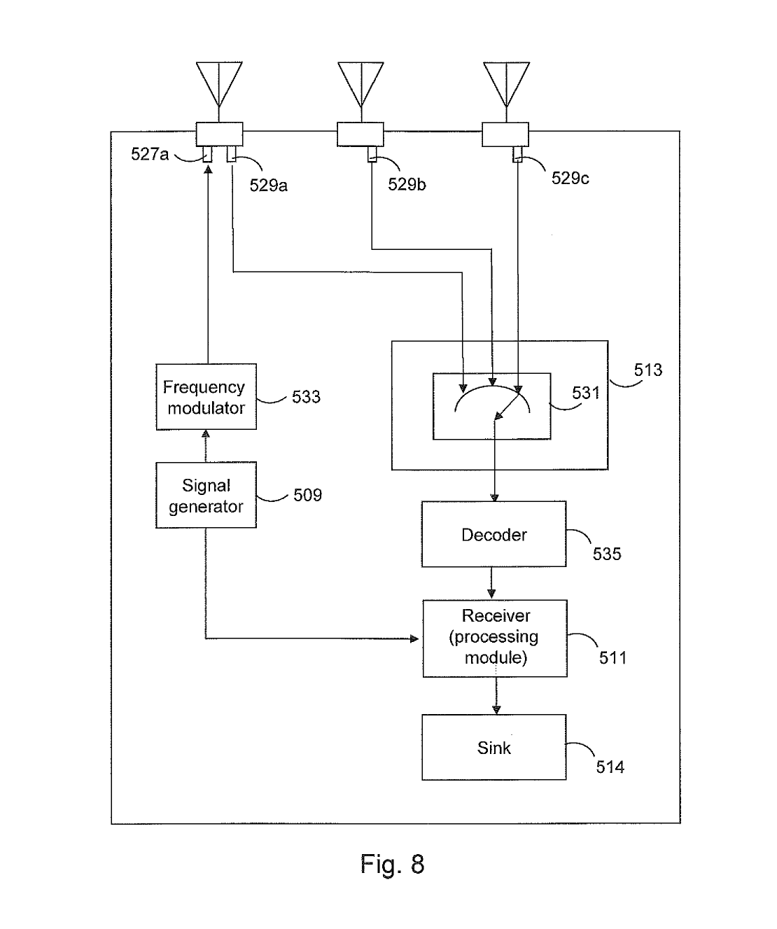

FIG. 8 shows an embodiment in which the first communication device includes a frequency modulator 533 and a decoder 535 which are used to process signals transmitted by and received from the antennas. In this example, the frequency modulator 533 is used to modulate the frequency of the signal generated by the signal generator 509. The frequency modulator may also use the original signal to generate a chirped signal, whose frequency varies over time. For example, the frequency of the signal may increase with time, or decrease with time. In this example, the bandwidth of the signal is of the order 80 MHz, spanning the range between 2.4-2.5 GHz (i.e. the frequency of the carrier wave in the chirped signal will vary from 2.4 GHz at its lower frequency end to nearer 2.5 GHz at the higher frequency end). The chirped output signal is conveyed to one of the antennas, which then proceeds to broadcast the signal as an interrogation signal.

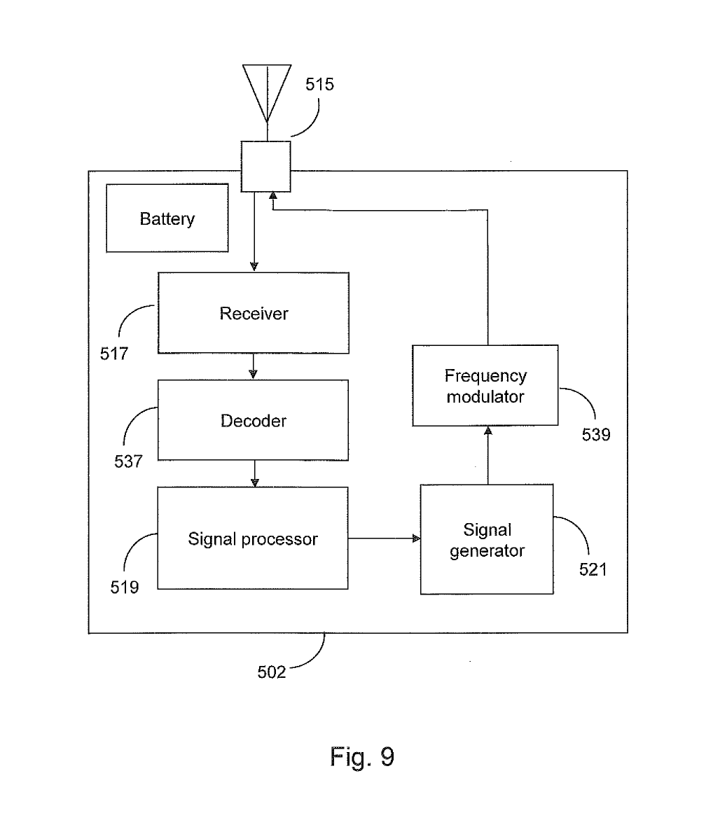

FIG. 9 shows an example of a second communication device that may be used to exchange signals with the communication device shown in FIG. 8. Similar to the example shown in FIG. 5, the second communication device includes a receiver 517, a signal processor 519 and a signal generator 521. In this example, the second communication device also includes a decoder 537 that is used to decode the signals received from the first communication device and a frequency modulator 539 for encoding the response signals that are to be sent back to the first communication device. The decoder 537 is used to recognise the coding present in the interrogation signal. The frequency modulator can then be used to encode the ensuing response signal with the same code, or an associated code.

Referring again to FIG. 8, the decoder 535 is used to decode the signals received from the second communication device. In common with the embodiment described above, the switch 531 of the multiplexer is used to select one of the antennas to sample the received signal from. The decoder is able to recover the signal sent from the second communication device by processing the signal using the original code applied by the frequency modulator.

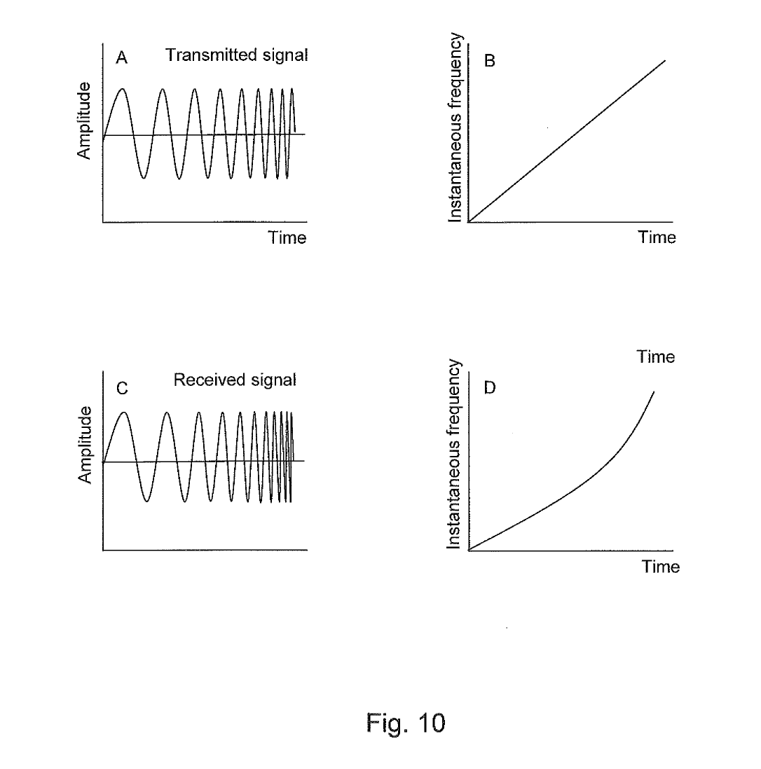

FIG. 10 shows an example of how the interrogation signals and the response signals (sent from the tag) may vary in frequency over time. FIG. 10A shows an example of how the interrogation signal that is sent from one of the antennas changes in frequency as a function of time. FIG. 10B shows the change in instantaneous frequency of the signal in time. As shown in FIG. 10B, the signal exhibits linear chirp; that is, the signal increases in frequency linearly over time.

FIG. 10C shows an example of a chirped response signal that is sent from the second communication device in response to the original interrogation signal shown in FIG. 10A. The response signal also exhibits chirp. However, as shown in FIG. 10D, the instantaneous frequency of the chirped signal no longer increases linearly with time, but varies non-linearly. The change in linearity of chirp itself provides a parameter which can be used to ascertain information about the location of the tag.

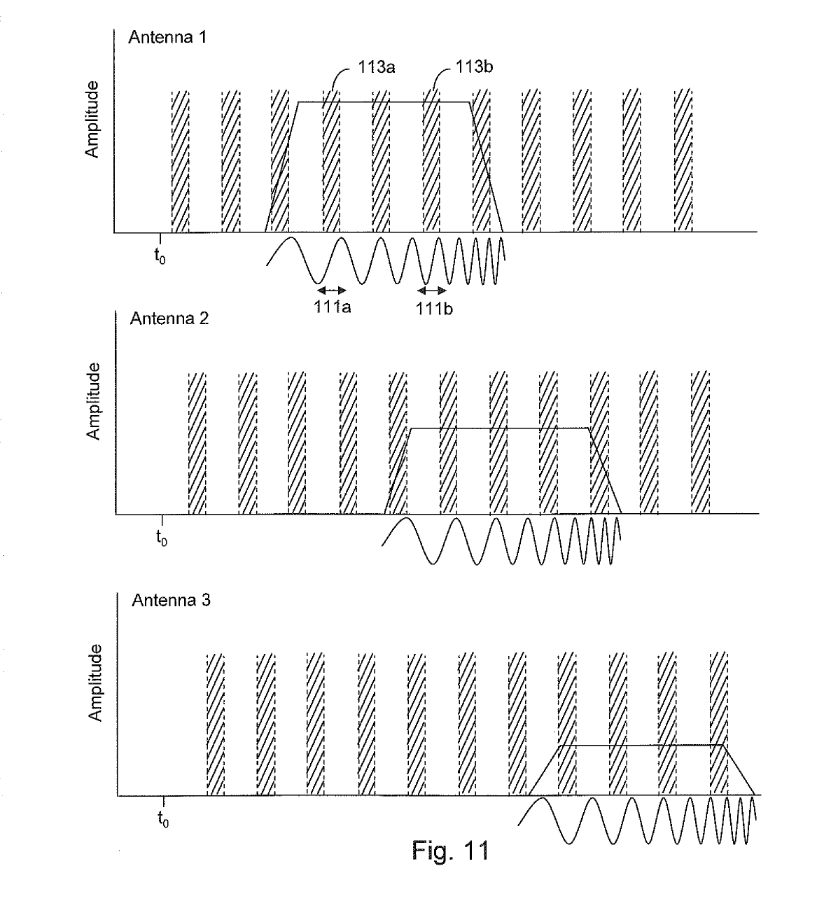

FIG. 11 shows an example of how the frequency modulation of the chirped signals may be detected by comparing the frequency of signals detected in the different sampling windows. Referring to the timeline for the first antenna, for example, the part of the response signal 111a that is sampled during the earlier time window 113a will have different frequency components to the part 111b that is sampled in the later time window 113b, as a result of the frequency chirp. Similarly, the parts of the response signal that are sampled from the second and third antennas in their respective time windows (and the frequency components comprised therein) will also differ from one another.

In general, embodiments described herein seek to determine the direction in which the tag is located from the first communication device. The direction information is obtained by extracting data (amplitude, time of arrival, frequency modulation, etc) from the response signals detected at each antenna, and comparing them with one another. In this respect, the actual geometry of the antenna layout can provide clues as to the tag's location.

In one example, the antennas may be arranged in a planar array, in which the antennas define the vertices of a polygon. For example, the antennas may be arranged at three points of a triangle, or there may be four antennas arranged at the vertices of a square or rectangle. By considering the response signals detected at neighbouring vertices of the polygon, the first communication device can enhance its detection of response signals, enabling it to “home in” on the location of the tag.

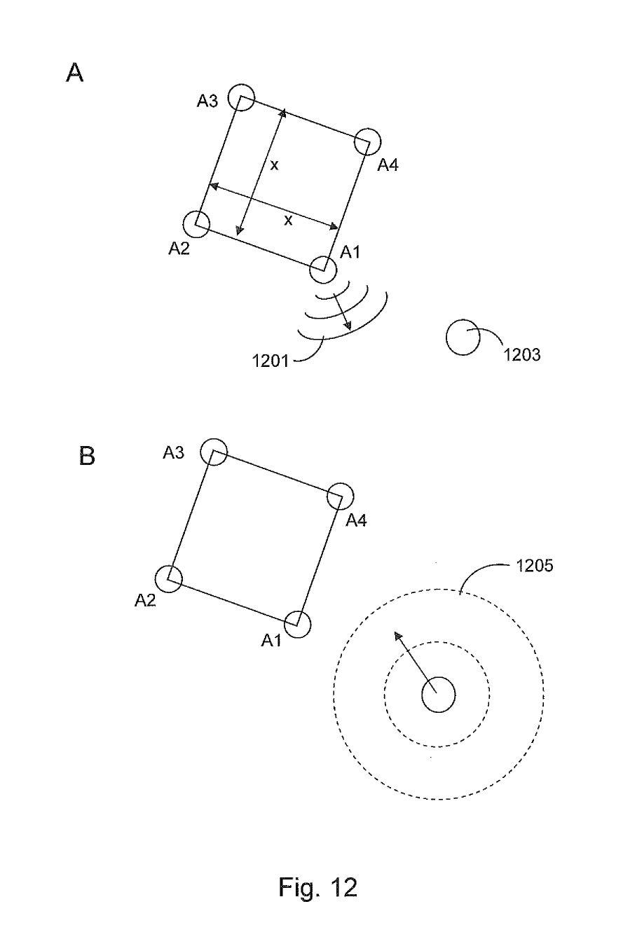

An example of how this may be achieved will be explained with reference to FIGS. 12 to 15. FIG. 12 shows an arrangement of antennas that may be used in the first communication device according to another embodiment. In this example, the first communication device comprises four antennas A1, A2, A3 and A4, which are arranged at corners of a square.

FIG. 12A shows the configuration of antennas at a first point in time, in which the antenna A1 is transmitting an interrogation signal 1201. FIG. 12B shows the device at a later point in time, where the tag 1203 has received the interrogation signal, and is now transmitting a response signal 1205 in return. The device may transmit subsequent interrogation signals in order to home in on the tag and track its movements.

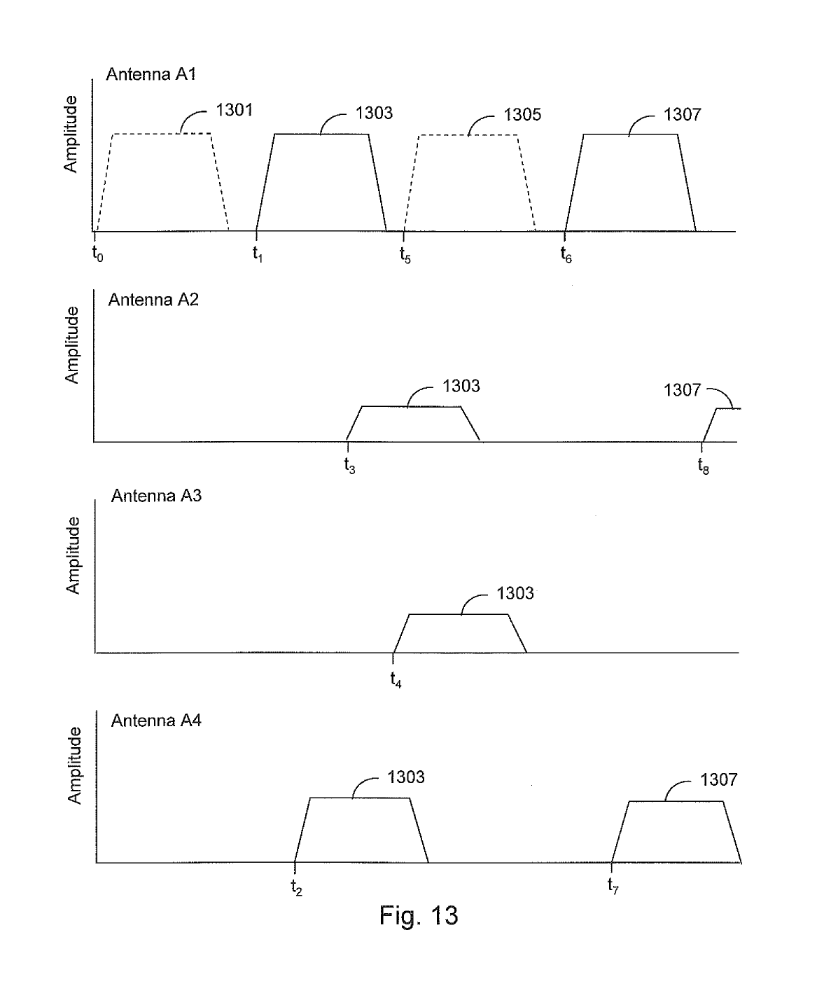

FIG. 13 shows a timeline of interrogation signals transmitted from the device and response signals received back from the tag. Starting at tₒ, the device transmits a first interrogation signal 1301 from antenna A1. At t₁ the antenna A1 begins to detect the signal 1303 sent from the tag in response to the first interrogation signal. Shortly after, at t₂, the same response signal 1303 arrives at antenna A4. Antenna A2 is the third antenna to detect the response signal 1303 at t₃ and antenna A3 is then the last antenna to receive the response signal 1303 at t₄. Thus, the time at which the antennas receive the response signal corresponds to their respective distance from the tag. Moreover, the amplitude of the response signal as detected by the antennas A1 and A4 is greater than that detected by the antennas A2 and A3, which are located further from the tag.

At t₅, the device transmits a second interrogation signal 1305. The first antenna thereafter receives a second response signal 1307 at t₆. The second response signal 1307 arrives at antenna A4 slightly later, at t₇ and arrives still later at antenna A2 at t₈. As can be seen from FIG. 13, the communication device first registers the response signal 1303 from antenna A1 and so is able to deduce that the tag lies closest to antenna A1 at that particular moment in time (the amplitude of the signal can similarly be used to deduce that antenna A1 lies closest to the tag). In subsequent rounds of interrogation/response, the device may adopt a new strategy for sampling the signals received at each antenna. In particular, once antenna A1 has been identified as being the closest antenna to the tag, the communication device may thereafter choose to increase the fraction of time for which antenna A1 is “on” i.e. the time for which antenna A1 as selected as input to the receiver. Doing so can help to maximise the strength of communication between the communication device and the tag, since the device will be tuned to the antenna where the response signal is strongest.

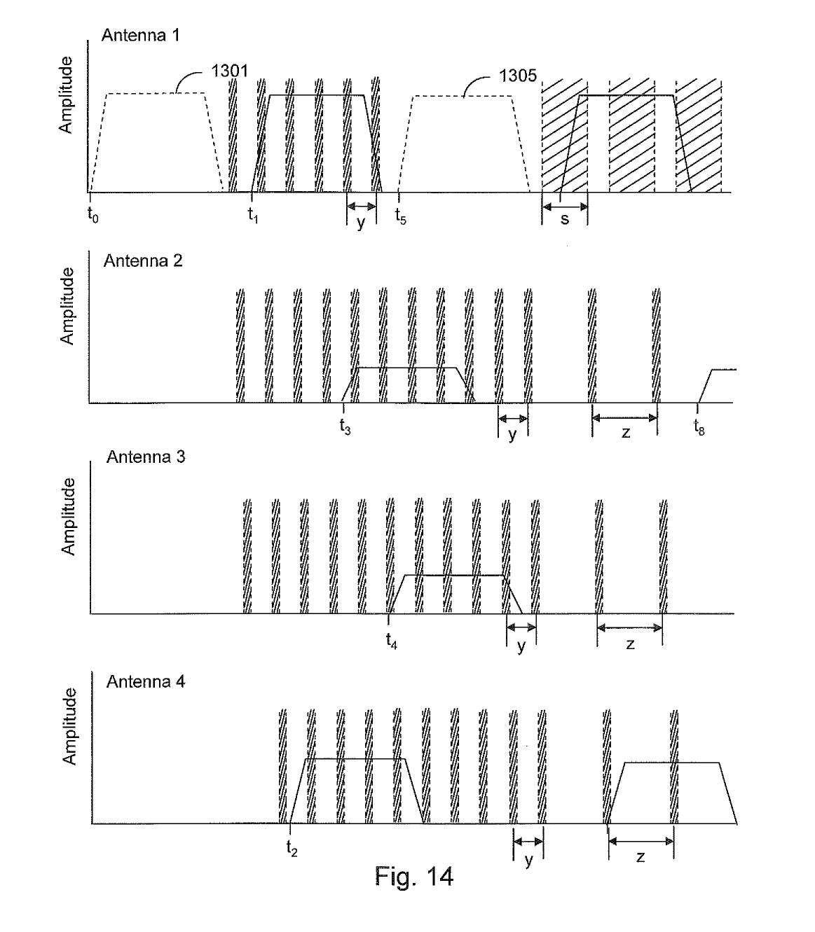

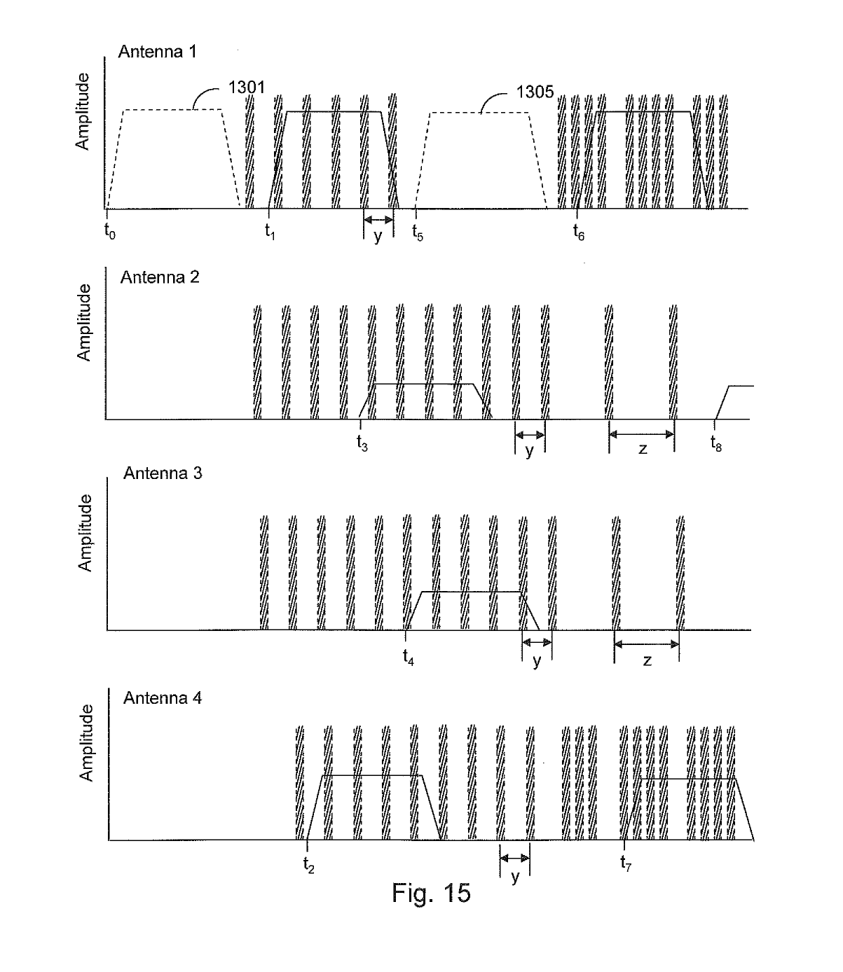

FIG. 15 shows an example sampling strategy for the sequence of response signals shown in FIG. 14. As before, the shaded regions represent time periods in which a particular antenna is selected as the input to the receiver. Following the transmission of the first interrogation signal 1301, the device begins to cycle through the four antennas, sampling the signal from each antenna in turn. In the example shown, the response signal is first detected in the second sampling window of antenna A1, and shortly thereafter in the second sampling window of antenna A4. The device only detects the response signal at antenna A2 in the fifth sampling window of that antenna and similarly only detects the response signal at antenna A3 in the sixth sampling interval of that antenna. Throughout the course of this time, each antenna is sampled at the same frequency, with an interval y between sampling windows.

After a certain interval, antenna A1 transmits the second interrogation signal 1305 (in the example shown, the device continues to sample the signal at antennas A2, A3 and A4 whilst antenna A1 is transmitting). Following the transmission of the second interrogation signal 1305, the antenna A1 returns to a receiving mode. Having determined from the first response signal that antenna A1 is the closest antenna to the tag, the sampling strategy now changes, such that antenna A1 is sampled for longer at the expense of the other antennas A2, A3 and A4. As shown in FIG. 14, following transmission of the second interrogation signal 1305, the sampling windows for the first antenna are set to have an increased duration s, whilst the other antennas are sampled less frequently, with the interval between the sampling windows increasing from y to z.

The device continues to sample the signal from the antennas A2, A3 and A4 (albeit less frequently) in order to ensure that the tag has not moved and is not now located closer to one of these other 3 antennas. In the event that the tag moves relative to the communication device and antenna A1 ceases to be the closest antenna to the tag, the device will detect this as a corresponding increase in the amplitude of the response signal received at one of the other antennas. In the event that such a change occurs, the device may subsequently choose to sample that newly identified closest antenna more frequently, in the manner described for antenna A1 above.

In addition to the sampling strategy shown in FIG. 14, other sampling strategies are also possible. FIG. 15 shows one example of a sampling strategy in which the pair of antennas having the strongest response signal is considered, rather than the individual antenna having the strongest response signal as shown in FIG. 14.

As before, following the transmission of the interrogation signal from antenna A1, the first communication device begins to cycle through the four antennas, sampling the signals detected at each in turn. Again as before, the communication device registers antenna A1 as being the first antenna to receive a response from the tag and antenna A4 as being the second antenna to receive a response from the tag. Having confirmed the receipt of the response signal at antennas A1 and A4 in subsequent sampling windows, and having yet to detect the presence of a signal at antennas A2 and A3, the communication device is able to determine that the tag must lie between antennas A1 and A4. Based on this, the communication device now refines the sampling process by focussing on antennas A1 and A4 and sampling those antenna signals more frequently; following the transmission of the second interrogation signal 1305, the communication device begins to alternate sampling of the signals from antennas A1 and A4, at the expense of sampling the signal from antennas A2 and A3. By increasing the frequency of sampling the signal at the antennas A1 and A4, the communication device is able to increase the signal to noise ratio from those antennas, allowing it to home in on precisely where the tag is located.

As before, precisely which two antennas constitute the “closest pair” to the tag may change over time, as the tag or first communication device move with respect to one another. In this example, therefore, when the first communication device increases the frequency of sampling from a given pair of the antennas, the device continues to periodically sample the signals from the other 2 antennas, albeit less frequently than before, in order to check whether the tag has moved with respect to the device (this is shown in FIG. 15 as the increased interval z between successive sampling windows for antennas A2 and A3). Where the device begins to detect signals at earlier intervals from a different pair of antennas to the presently identified “closest pair of antennas”, the device may in turn then increase the frequency of sampling from the newly identified pair of antennas, whilst reducing the frequency of sampling from the other antennas.

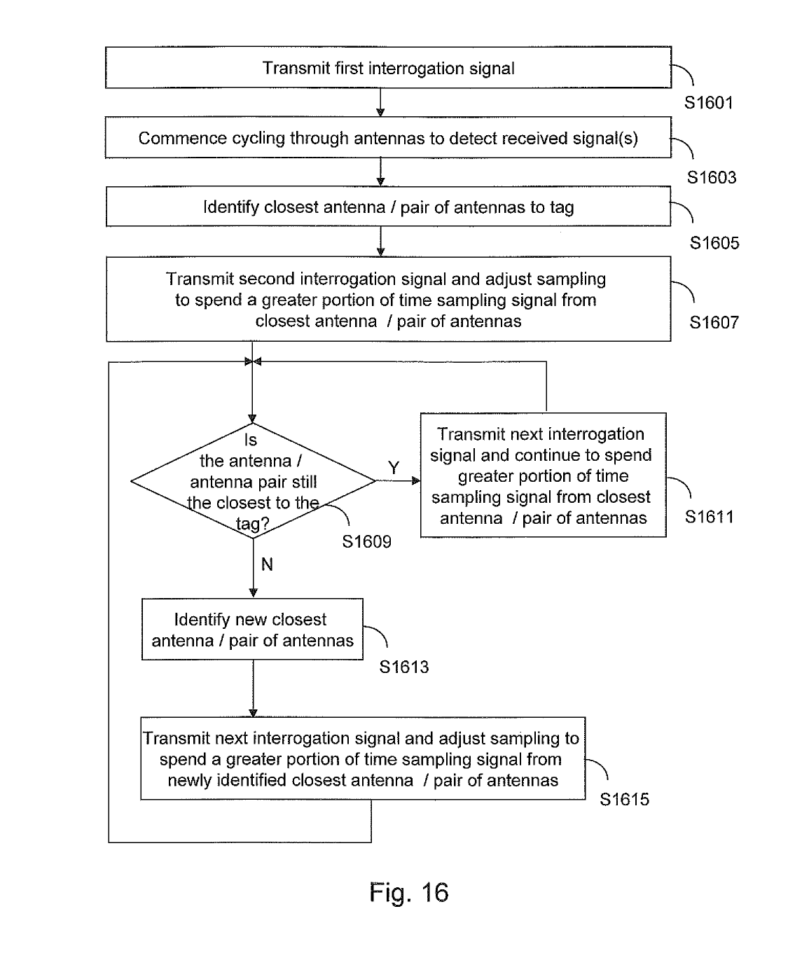

The sequence of steps employed in choosing a sampling strategy for the different antennas is summarised in the flowchart of FIG. 16. Following the transmission of the first interrogation signal in step S1601, the communication device commences cycling through each antenna to detect signals received by those antennas (step S1603). In step S1605, the device determines which one of the antennas (or pair of antennas) is closest to the tag. The device then transmits a second interrogation signal and thereafter increases the fraction of time spent sampling the signal from the antenna or pair of antennas identified as being closest to the tag (step 1607).

In step S1609, the device determines, based on signals received in response to the second interrogation signal, whether or not the currently selected antenna or pair of antennas is still closest to the tag. If yes, the device transmits a new interrogation signal and continues to sample that same antenna or pair of antennas for longer compared to the other antenna(s) (step S1611). Following this, the method returns to Step S1609 and the process is repeated. In the event that the outcome of Step 1609 is no i.e. the signals received from the tag in response to the previous interrogation signal indicate that the tag's position relative to the communication device has changed and the tag is now closer to a different antenna or pair of antennas, the sequence proceeds to step S1613 and S1615. Here, the communication device identifies which antenna or pair of antennas is closest to the tag and adjusts the sampling method accordingly. The sequence then returns to Step 1609 and repeats.

In the examples described above, the first communication device is configured to transmit interrogation signals from a single antenna. However, the interrogation signals need not be transmitted solely by one antenna. Examples will now be described in which interrogation signals are transmitted by more than one antenna in the first communication device. Transmitting the signals from multiple antennas can increase the signal to noise ratio, and maximise the region of space over which the interrogation signals propagate, increasing the effective range of the device.

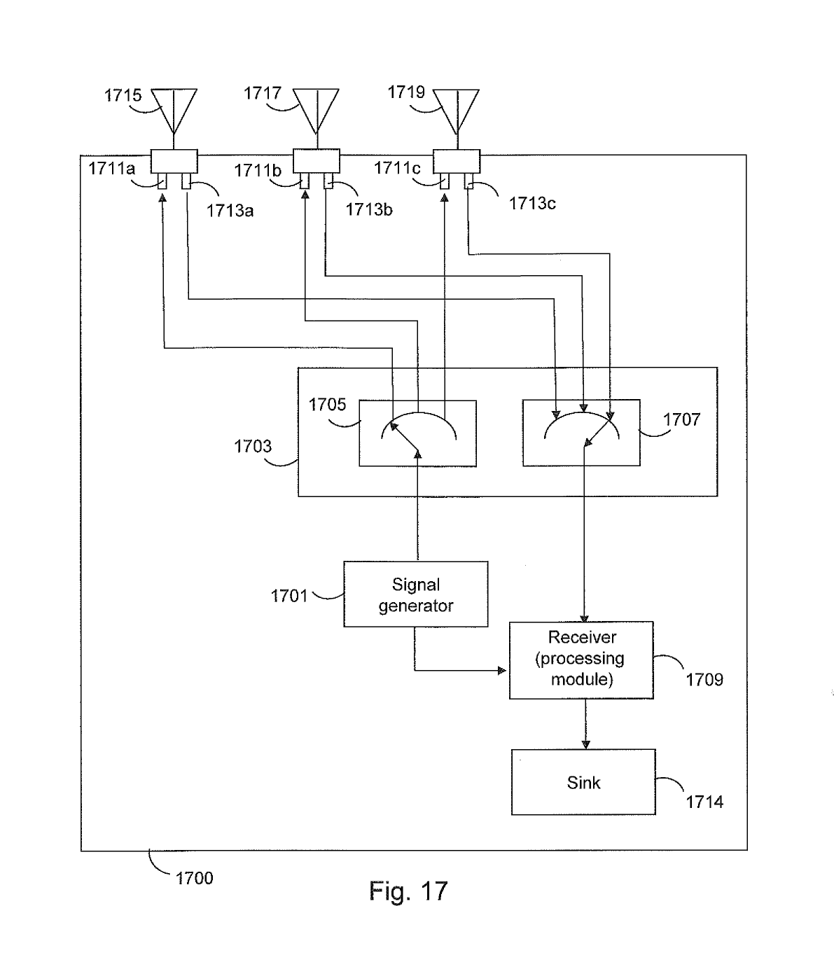

FIG. 17 shows a view of the components of the first communication device 1700 according to the present embodiment. The configuration is similar to that shown in FIG. 6, however, the multiplexer 1703 now includes first 1705 and second 1707 switches that are coupled to the signal generator 1701 and receiver 1709, respectively. The first switch 1705 is used to select one of the three antenna input feeds 1711a, 1711b, 1711c to forward the generated signal to. In this way, the first switch determines which of the three antennas should broadcast an interrogation signal at a particular time. The second switch 1707 of the multiplexer is connected to the output feeds 1713a, 1713b, 1713c of the three antennas and is used to select one of those three output feeds to be input into the receiver 1709.

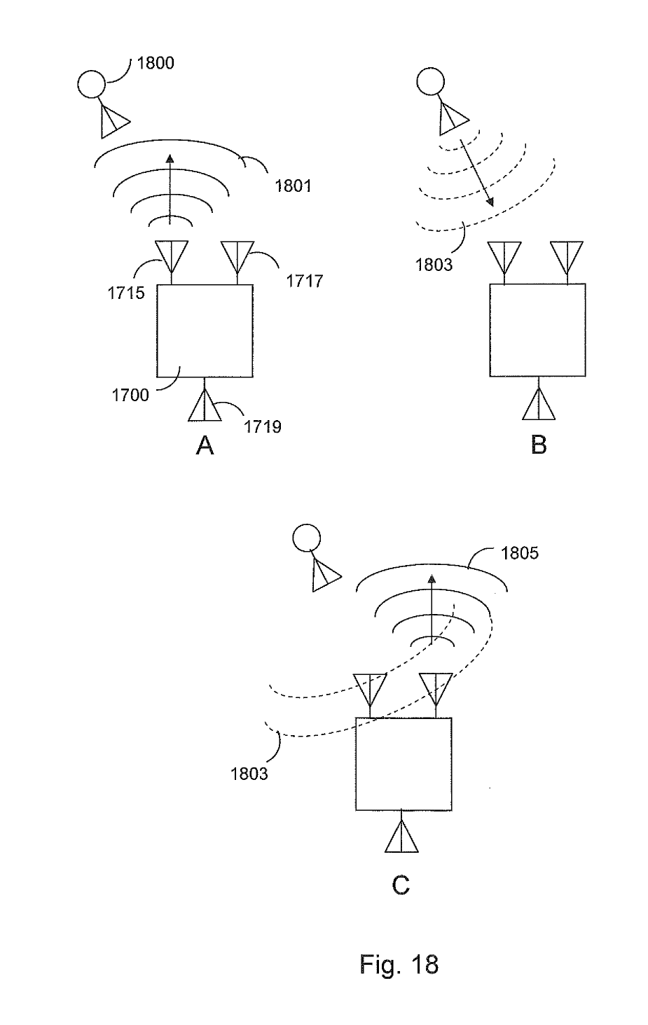

FIG. 18 shows an example sequence of transmissions from the first communication device 1700 and the tag 1800 in the present embodiment. Beginning with FIG. 18A, there is shown a first moment in time in which the first antenna 1715 is transmitting a first interrogation signal 1801, whilst the second 1717 and third 1719 antennas are not currently transmitting. At this stage, the tag 1800 has yet to receive a signal from either of the antennas. Therefore, the tag 1800 is presently inactive.

FIG. 18B shows the two communication devices at a later point in time, following the receipt of the first interrogation signal 1801 by the tag. Having received the first interrogation signal, the second communication device has now begun to broadcast its own signal 1803 in response. The first antenna 1715 has itself now ceased to transmit, and instead switched to a receiving mode where it can receive and process response signals emitted by the tag.

FIG. 18C shows a third moment in time in which the response signal 1803 has progressed further towards the communication device. At this point, the second antenna 1717 has switched to a transmission mode, and is now broadcasting its own interrogation signal 1805.

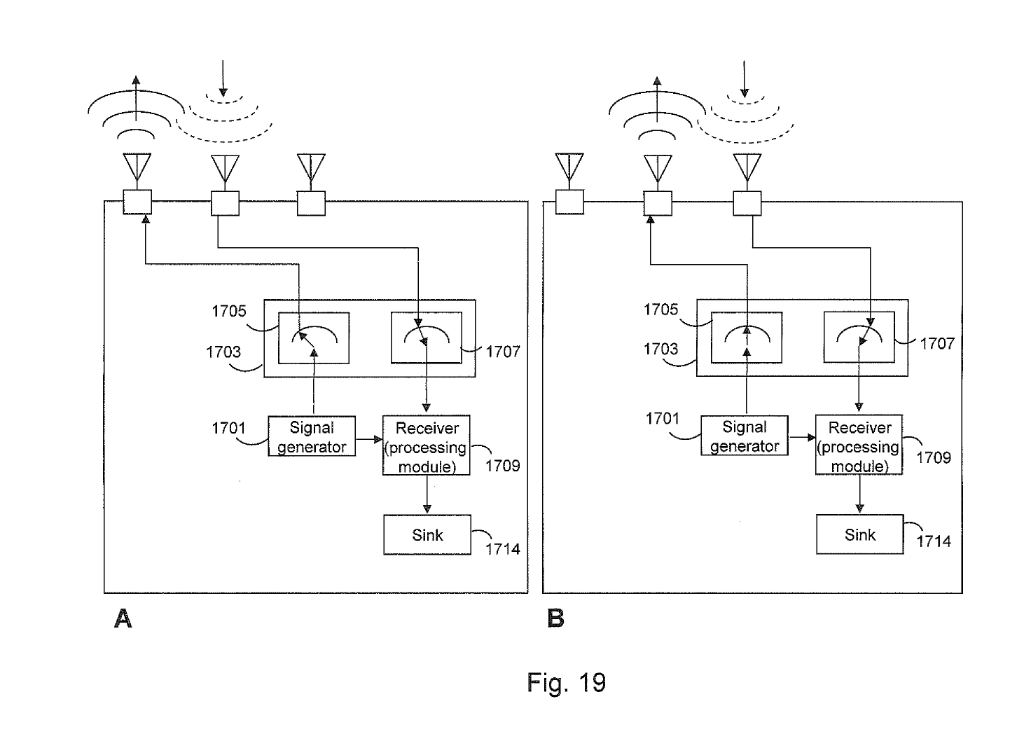

FIG. 19 shows an example of how the multiplexer of FIG. 17 may work in practice. At the time point shown in FIG. 19A, the first antenna is active as a transmitter; the first switch 1705 is set to connect the input feed of the first antenna to the signal generator 1701, such that a signal generated by the signal generator will be directed to the first antenna and broadcast as an interrogation signal. Concurrently, the second switch is set to connect the output feed of the second antenna to the receiver. The receiver is, therefore, set to sample signals received by the second antenna. The third antenna, meanwhile, is not connected to either switch. Thus, whilst the third antenna may also be receiving signals transmitted by the second communication device, only those signals received by the second antenna will be sampled and processed in the first communication device at this point in time.

FIG. 19B shows the configuration of the multiplexer at a later point in time. Here, both the first and second switches have changed their configuration. The first switch is now set to connect the signal generator to the input feed of the second antenna, and the second switch is set to connect the receiver to the output feed of the third antenna. Thus, at the time shown in FIG. 19B, the second antenna is transmitting an interrogation signal, whilst the receiver is set to sample any signals being received by the third antenna. The first antenna meanwhile is now in a similar state to that of the third antenna in FIG. 19A; whilst the first antenna is capable of receiving signals transmitted by the second communication device, the receiver is presently sampling signals received by the third antenna only. Therefore, the signals received by the first antenna at this time are not processed.

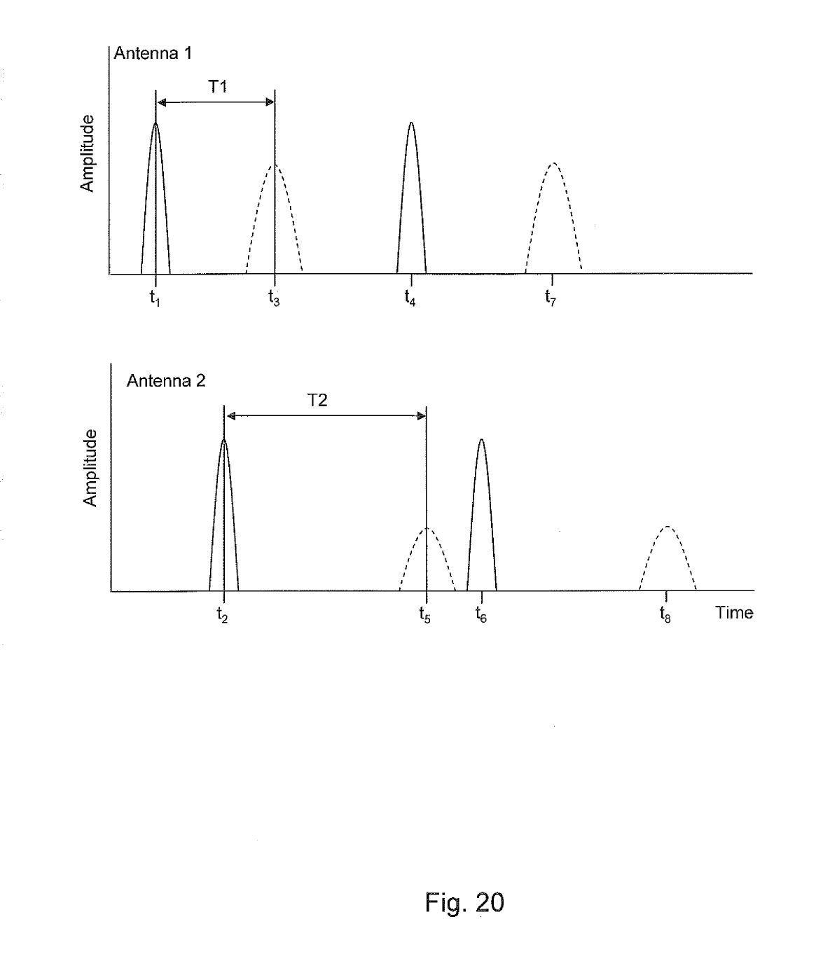

FIG. 20 shows an example time series of signals transmitted from and received by the antennas of the first communication device in an embodiment. For clarity, only the signals from the first and second antennas are shown, with the two antennas being represented on separate axes.

As shown on the top axis, a first interrogation signal is transmitted by the first antenna at time t₁. The second antenna subsequently broadcasts a second interrogation signal at t₂. Thus, the interval t₁-t₂ represents the offset in time of transmissions from the two antennas.

In due course, the second communication device receives the first interrogation signal transmitted by the first antenna, and broadcasts a response signal, which is received by the first antenna at time t₃. The interval t₁-t₃, denoted as T1 in FIG. 6, therefore represents the sum of the time taken for the first interrogation signal to reach the second communication device and for the ensuing response signal to reach the first antenna.

At time t₄, the first antenna has reverted back to a transmission mode and emits a new interrogation signal. At t₅, the second antenna, which is still in receiving mode, receives its first response signal from the second communication device (i.e. the signal transmitted by the second communication device in response to the second interrogation signal that was sent at t₂). The interval t₂-t₅, denoted T2 in FIG. 20, therefore, represents the sum of the time taken for the second interrogation signal to reach the second communication device and for the ensuing response signal to reach the second antenna. Since T2 is longer than T1, one is able to conclude that the second communication device lies closer to the first antenna than the second antenna.

The second antenna subsequently switches back to a transmission mode and emits a new interrogation signal at time t₆. The first and second antennas receive subsequent response signals from the second communication device at t₇ and t₈ respectively. As before, the interval between the interrogation signal and the response signal for the first antenna is shorter than that for the second antenna.

In addition to the arrival time of each response signal, the amplitude of the response signals can also provide information as to the location of the tag. For example, as shown in FIG. 20, the first and second antennas both broadcast signals having the same amplitude. However, the response signals received by the first antenna are of greater amplitude than those received by the second antenna. The amplitude of the response signal received at the second antenna is smaller, because the second antenna lies further away from the tag; the response signal is, therefore, dispersed over a greater volume of space before it reaches the second antenna.

The receiver processing module can calculate distance information based on the measured interval between an antenna's transmission, and its receipt of a response signal from the second communication device. By correlating differences in amplitude and/or time of arrival of the response signal for the respective antennas, it is possible to build up information concerning the location of the second communication device.

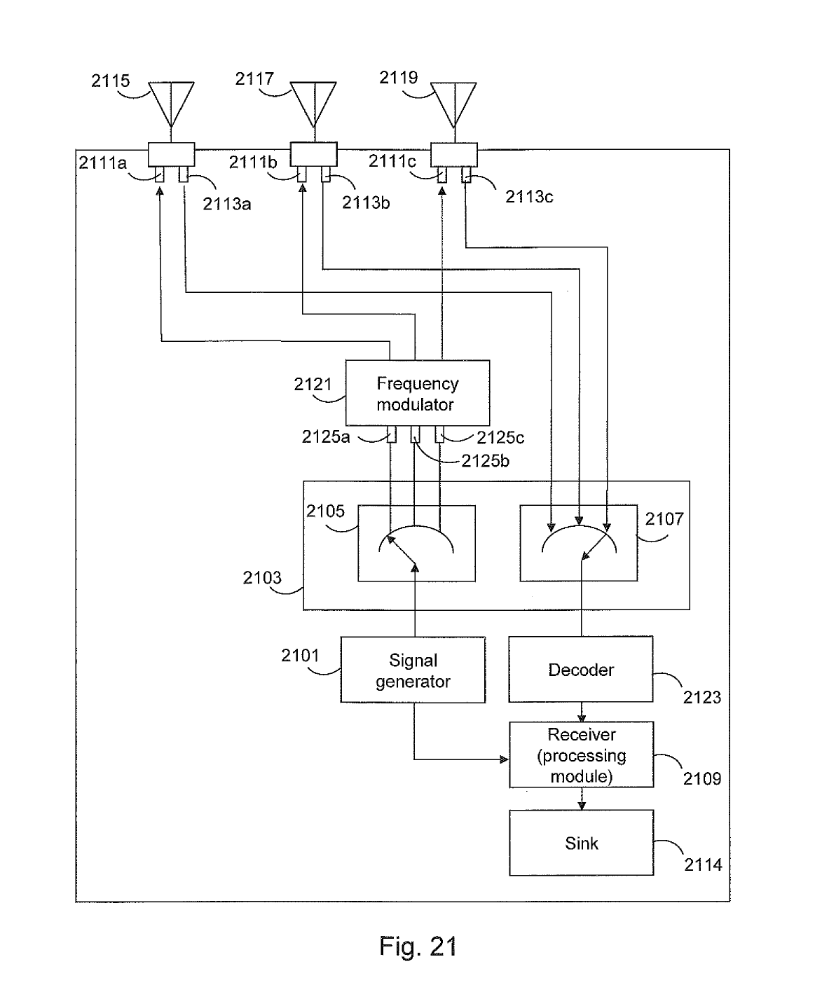

FIG. 21 shows components of a first communication device according to another embodiment, which combines features of the embodiments shown in FIGS. 8 and 18.

As in the example shown in FIG. 8, the first communication device includes a frequency modulator 2121 and a decoder 2123 that are used to process signals transmitted by, and received from the antennas 2115, 2117, 2119. In this example, the frequency modulator 2120 is used to modulate the frequency of the signal generated by the signal generator 2101. The frequency modulator 2121 may also use the original signal to generate a chirped signal, whose frequency varies over time. For example, the frequency of the signal may increase with time, or decrease with time. In this example, the bandwidth afforded by the frequency modulator is of the order 80 MHz, spanning the range between 2.4-2.5 GHz (i.e. the frequency of the carrier wave in the chirped signal may vary from 2.4 GHz at its lower frequency end to nearer 2.5 GHz at the higher frequency end). Each antenna may be assigned its own code that determines the precise way in which the frequency of the signal should vary over time. Each antenna may transmit using the entire 80 MHz bandwidth, or use a particular band of frequencies within the available 80 MHz band. For example, the carrier frequency for signals transmitted from each respective antenna may span different 20 MHz bands within the total 80 MHz bandwidth available.

The signal generated by the signal generator is transmitted from the multiplexer to the frequency modulator through one of several ports 2125a, 2125b, 2125c, where each port corresponds to a different antenna. The frequency modulator is able to determine the configuration of the switch based on which one of the ports is active this in turn indicates which one of the antennas it is desired to transmit from at a particular moment in time.

Having established which antenna is to be used for transmission, the frequency modulator 2121 encodes the signal with a code that is particular to that antenna. For example, the frequency modulator may cause the frequency of the signal to vary over time according to a predetermined format, which is specific to the selected antenna. The modulated output signal is conveyed to the input feed of the antenna in question, which then proceeds to broadcast the signal as an interrogation signal.

Thus, each time the first switch in the multiplexer switches to select a new antenna for broadcasting, the signal transmitted by that antenna may be encoded with a specific code which is expressed in the frequency variation of that signal. The interrogation signals that are broadcast by each antenna may, therefore, have a specific frequency variation that is unique to the antenna in question.

The first communication device of the embodiment shown in FIG. 21 may be used to exchange signals with the communication device shown in FIG. 9. In this example, the decoder of the second communication device may be used to recognise the coding present in the interrogation signal. The frequency modulator can then be used to encode the ensuing response signal with the same code, or an associated code. It follows that the signals broadcast by the second communication device may have different formats, depending on which of the antennas the original interrogation signal was broadcast from.

Referring again to FIG. 21, the decoder 2123 of the first communication device is used to decode the signals received from the second communication device. In common with the embodiments described above, the multiplexer switch 2107 is used to select one of the antennas to sample the received signal from. The decoder is connected in line with the output of the second switch, and is able to determine which one of the antenna signals the received signal is presently being sampled from. The decoder 2123 is able to recover the signal sent from the second communication device by processing the signal using the original code applied by the frequency modulator.

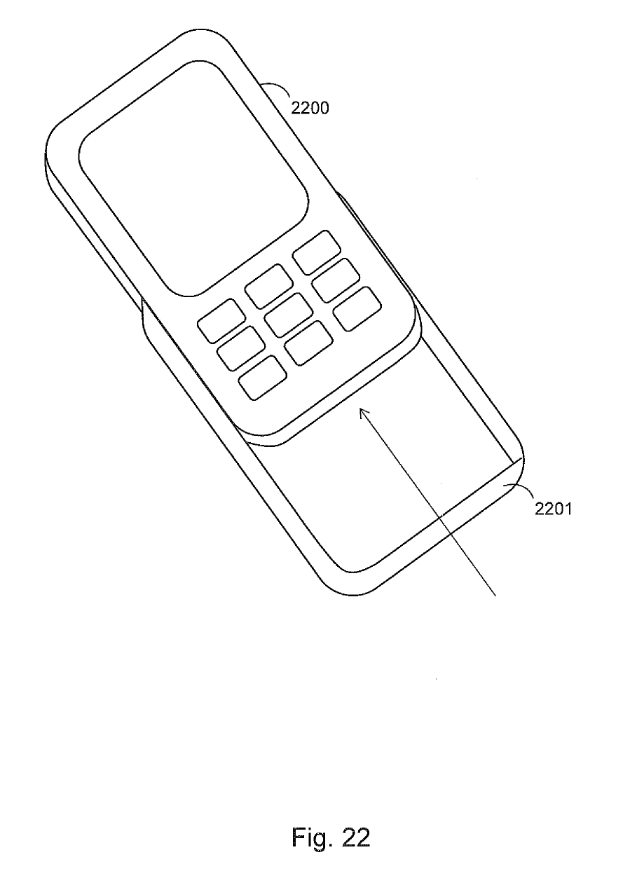

FIG. 22 shows an example of how the first communication device may be incorporated in an appliance such as a mobile phone 2200. For example, the first communication device may be incorporated as part of a smart phone. In this embodiment, the device is provided as a sleeve or jacket 2201 that at least partially encases the phone 2200. Other arrangements are also possible. For example, the components of the first communication device, including the antennas may be integrated within the phone itself.

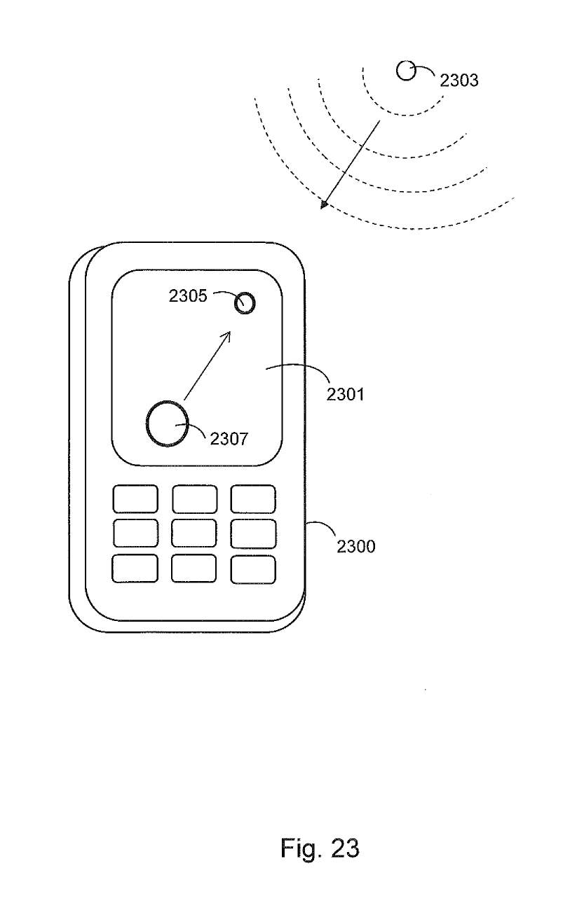

In this embodiment, data from the first communication device can be uploaded to the phone itself, which can then display the location of the second communication device from the phone. An example is shown in FIG. 23, which shows a smart phone 2300 having a visual display screen 2301 such as may be used to display images including, for example, roadmaps. The phone includes a tracking device that is used to identify the direction in which a second communication device 2303 is located. Upon determining the location of the second communication device, the information is uploaded to the phone in order to display the information on the screen. For example, the phone may display the position 2305 of the second communication device relative to the user 2307, indicating the direction in which the user should travel in order to reach the second communication device.

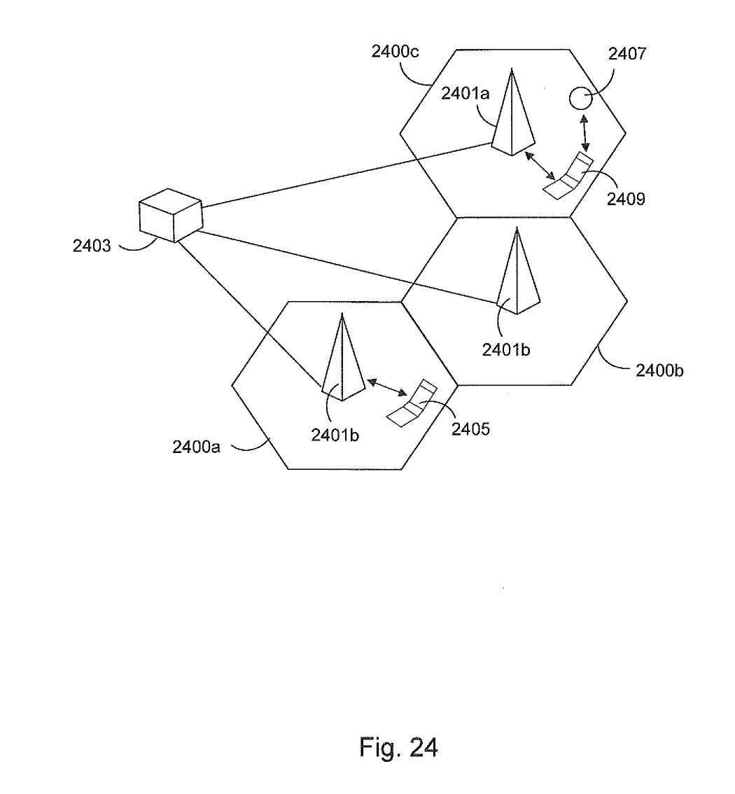

In some embodiments, the tracking device may be capable of transmitting information concerning the location of the identification tag to another tracking device over a wireless network. FIG. 24 shows one example in which the location information is transmitted over a mobile phone network.

In more detail, the mobile phone network of FIG. 24 comprises a series of hexagonal cells 2400a, 2400b, 2400c, with each cell being served by a respective base station 2401a, 2401b, 2401c that is linked to an exchange 2403. A first communication device 2405 (tracking device) is located in one of the cells 2400a of the network, and is paired with a second communication device (identification tag 2407) that is located in another cell 2400c of the network. The distance between the two cells is such that the identification tag lies outside the range of the first tracking device; the identification tag is incapable of receiving interrogation radio signals sent from the first tracking device.

A second tracking device 2409 is located within the same cell as the identification tag. The second tracking device has the same functionality as that of the first tracking device, and lies within range of the identification tag. The second tracking device is therefore able to ascertain the direction in which the tag 2407 lies by using the same method discussed above in relation to the previous embodiments. Having established the direction in which the identification tag is located, the second tracking device is able to communicate this information to the first tracking device by transmitting over the mobile phone network. In this way, the first tracking device is able to deduce the location of the tag even when the tag lies outside the range of its own interrogation signals.

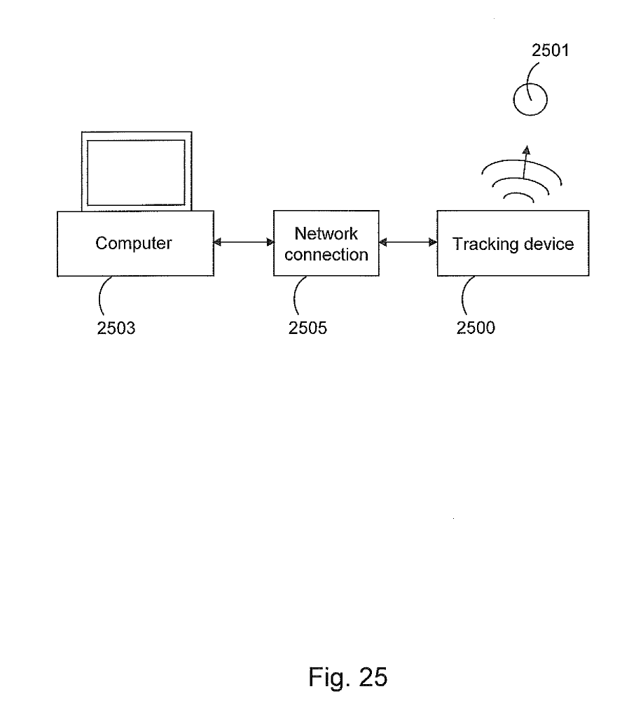

In an alternative embodiment, the tracking device may communicate the location information to a computer workstation, as shown in FIG. 25. In this example, the tracking device 2500 communicates with the identification tag 2501 in order to establish the location of the identification tag with respect to the tracking device. The tracking device then transmits the location information to a computer 2503 over a network connection 2505, which may be wireless, for example. The computer itself has a desktop application which can show the tag location. Such a design may be implemented, for example in buildings (care homes, hospitals, evacuation, etc). A building or area map can be added to show each tag's position within this context.

While certain embodiments have been described, these embodiments have been presented by way of example only, and are not intended to limit the scope of the invention. Indeed, the novel methods, devices and systems described herein may be embodied in a variety of forms. For example, although in many of the embodiments described above the first communication device functions primarily as the tracking device, and the second communication device functions as an identification tag, it is possible for these roles to be reversed, and for the first communication device to function as the identification tag. Here, a tracking device may initiate communication with the identification tag (first communication device) by broadcasting an enquiry signal. On receipt of the enquiry signal, the identification tag may then begin the process of cycling through transmissions from each of the plurality of antennas, whilst the tracking device provides the necessary response signals from its antenna. In such embodiments, it will be the tag that determines the direction in which the tracking device lies located. The tag can communicate this information to the tracking device, which in turn can invert the information to determine the location of the tag with respect to the tracking device. Thus, the electronics used to determine the locations of the tag/tracking device with respect to one another may be housed in either one of the tag and tracking device.

In other embodiments, the first communication device may function as both a tracking device, and an identification tag. For example, the first communication device may provide response signals indicating its location as well as sending out interrogation signals to other tags; this can allow two people who each have their own tag/tracking device to coordinate their movements to rendezvous at a certain position, for example.

Various submissions, substitutions and changes in the form of the methods and systems described herein may be made without departing from the spirit of the invention. The accompanying claims and their equivalents are intended to cover such forms or modifications as would fall within the scope and spirit of the invention.

1. A communication device operable to communicate with another communication device to determine the location of the two devices with respect to one another,
the communication device having a plurality of antennas and being configured to transmit an interrogation radio wave signal to the other communication device from at least one of the antennas,
the communication device being configured to detect at each one of the antennas a radio wave reply signal sent from the other communication device in response to the interrogation signal;
the communication device including a processing module for processing the reply signal received at each antenna, the processing module being configured to determine a direction in which the other communication device is located based on characteristics of the reply signal as received at each antenna.

2. A communication device according to claim 1, wherein the processing module is operable to sample the signal from each antenna in a plurality of sampling windows, wherein the sampling windows used for each individual antenna are offset in time from the sampling windows used for the other antennas.

3. A communication device according to claim 2, wherein the sampling windows for each antenna are wholly offset from one another, such that only one antenna is sampled at a time.

4. A communication device according to claim 2, wherein the processing module is operable to sample the signal from each antenna at a rate in excess of 1 GHz.

5. A communication device according to claim 1, wherein the processing module is operable during the period in which said at least one antenna is transmitting the interrogation signal to sample the signal from the other antennas.

6. A communication device according to claim 1, wherein the communication device includes a switch for selecting which one of the antenna signals is to be input to the processing module for sampling at any one time.

7. A communication device according to any one of the preceding claims, wherein the processing module is configured to determine the direction in which the other communication device is located at least partly based on the time intervals that occur between sending the interrogation signal from said at least one antenna and receiving the response signal at each antenna.

8. A communication device according to claim 1, wherein the processing module is configured to determine the direction in which the other communication device is located at least partly based on the difference in amplitude between the signals that are received at each antenna.

9. A communication device according to claim 1, wherein the communication device is configured to transmit a signal to the other communication device indicating the direction in which the communication device is located with respect to the other communication device.

10. A communication device according to claim 1, wherein the antennas of the communication device are configured to transmit at frequencies in the range 2.4-2.5 GHz.

11. A communication device according to claim 1, wherein each interrogation signal comprises a chirped signal.

12. A communication device according to claim 11, wherein the reply signal received from the other communication device comprises a chirped signal.

13. A communication device according to claim 1, wherein the device is operable to determine the antenna that is closest to the other communication device based on characteristics of the reply signal as received at each antenna.

14. A communication device according to claim 13, wherein the device is operable to transmit a second interrogation signal in response to the reply signal sent from the other communication device;
wherein following transmission of the second interrogation signal, the communication device is operable to adjust the sampling windows for the antennas, such that the processing module samples the signal from the antenna identified as being closest to the other communication device for a greater portion of time compared to the other antennas.

15. A communication device according to claim 14, wherein on receiving a reply signal sent from the other communication device in response to the second interrogation signal, the communication device is configured to reassess which one of the antennas is closest to the other communication device; and
where the communication device determines that a different one of the antennas is now closest to the other communication device, the communication device is configured to adjust the sampling windows, so that following the transmission of a further interrogation signal from the communication device, the communication device will sample the signal from the antenna newly identified as being closest to the other communication device for a greater portion of time compared to the other antennas.

16. A communication device according to claim 1, wherein the device is operable to determine the pair of antennas that are closest to the other communication device based on characteristics of the reply signal as received at each antenna.

17. A communication device according to claim 16, wherein the device is operable to transmit a second interrogation signal in response to the reply signal sent from the other communication device;
wherein following transmission of the second interrogation signal, the communication device is operable to adjust the sampling windows for the antennas, such that the processing module samples the signal from the pair of antennas identified as being closest to the other communication device for a greater portion of time compared to the other antennas.

18. A communication device according to claim 17, wherein on receiving a reply signal sent from the other communication device in response to the second interrogation signal, the communication device is configured to reassess which pair of antennas is closest to the other communication device; and
where the communication device determines that a different pair of antennas is now closest to the other communication device, the communication device is configured to adjust the sampling windows, so that following the transmission of a further interrogation signal from the communication device, the communication device will sample the signal from the pair of antennas newly identified as being closest to the other communication device for a greater portion of time compared to the other antennas.

19. A communication device according to claim 1, wherein the communication device is configured to transmit interrogation signals from a plurality of the antennas.

20. A communication device according to claim 19, wherein the communication device includes a multiplexer for selecting which one of the antennas is to transmit an interrogation signal and which one of the antennas is to be sampled by the processing module at any one time.

21. A communication device according to claim 19, wherein the communication device is configured to assign each antenna its own code for modulating the frequency of interrogation signals transmitted from that antenna.

22. A communication device according to claim 19, wherein the communication device is configured to assign each antenna a different frequency or band of frequencies for transmitting interrogation signals.

23. A communication device according to claim 1, wherein the communication device is operable to communicate with a plurality of other communication devices, and the interrogation signals sent to any one of the other communication devices are encoded in a format that is specific to that device.

24. A communication device according to claim 1, wherein the communication device includes a means for displaying the direction in which the other communication device is located with respect to the communication device.

25. A communication device according to claim 1, wherein the communication device includes at least 3 antennas.

26. A communication device according to claim 1, wherein the antennas are arranged in a planar array, in which each antenna defines a vertex of a polygon.

27. A communication device according to claim 26, wherein the communication device includes 4 antennas located at the corners of a square.

28. A system for tracking the location of an object of interest, the system comprising a communication device according to any one of the preceding claims and a second communication device, the second communication device being configured to receive interrogation signals sent from the communication device and to transmit reply signals in response back to the communication device.

29. A system according to claim 28, wherein the communication device is configured to transmit interrogation signals from a plurality of the antennas with each antenna being assigned its own code for modulating the frequency of interrogation signals transmitted from that antenna;
the second communication device being configured to recognise the format of each interrogation signal and to encode the respective response signals using the same format.

30. A method of tracking the position of a second communication device with respect to a first communication device having a plurality of antennas, the method comprising:
sending an interrogation radio wave signal to the second communication device from at least one of the antennas of the first communication device;
receiving a radio wave reply signal sent from the second communication device at each one of the antennas;
and determining a direction in which the second communication device is located based on characteristics of the reply signal as received at each antenna.

31-51. (canceled)
